(19) United States
(12) Patent Application Publication
(10) Pub. No.: US 2005/0021723 A1
(43) Pub. Date: Jan. 27, 2005

(54) Multivendor network management

(76) Inventor: Jonathan Saperia, Stow, MA (US)

Correspondence Address: FISH & RICHARDSON PC, 225 FRANKLIN ST, BOSTON, MA, 02110, US

(21) Appl. No.: 10/867,018

(22) Filed: Jun. 14, 2004

Related U.S. Application Data
(60) Provisional application No. 60/478,904, filed on Jun. 13, 2003.

(51) Int. Cl. G06F 15/173

(52) U.S. Cl. 709/223

(57) ABSTRACT

A method executing network management software for managing devices on a network, includes mapping high level abstract objects to specific vendor, model, firmware, release, or configuration-specific objects to provision and manage the network. The objects may be management objects that are independently defined from a method of access protocol used to convey the objects to the managed devices.

### RELATED APPLICATIONS

This application claims priority from and incorporates herein U.S. Provisional Application No. 60/478,904, filed Jun. 13, 2003, and titled “NETWORK MANAGEMENT”.

### BACKGROUND

A network is a series of nodes, e.g., devices interconnected by communication paths.

Networks may interconnect with other networks and include subnetworks. Networks also may be characterized in terms of spatial distance, e.g., local area networks (LAN) or wide area networks (WAN). Networks include network devices such as routers, switches, and so forth. A network operator configures and monitors routers and other network devices within the network.

### SUMMARY

Typically, network devices come from different vendors that may have different sets of management data. Even network devices from the same vendor may have different sets of management data. Because of the different sets of management data amongst network devices, the network operator is required to be knowledgeable about the details of each and every network device before configuring and monitoring each device. The network operator must also be familiar with how to map the differences between vendors and different management technologies (protocols) to one another in order to configure a network to behave in a correct fashion.

In addition, the network operator is required to be knowledge to configure the diverse network devices in concert with other network devices to produce an overall network configuration. For example, if the network operator sets up a network that includes different routers and/or other network components such as bandwidth managers or firewalls, the network operator would determine the desired behavior of the overall network and translate that desired behavior into product-specific configuration commands each time a router was added or monitored or the configuration was of the network was modified. Typically, the network operator ‘hard codes’ this information into scripts that configure and/or monitor the network devices.

In order to understand the impact of a failure in a network, the network operator needs to understand the configuration of the network. For example, if an interface fails, it means one course of action if it is a backup or used for unimportant services. If, on the other hand, the interface serves critical information, then the course of action taken to restore service might be quite different. In addition, configuration errors account for a significant percentage of network failures. Thus, the relationship between fault and configuration data is also important as well as other types of data related to configuration information such as accounting, performance and security. Relationships are built into each data object in the system in order to effectively allow the management system to identify configuration related failures and service level violations in addition to failures and violations related to capacity or other factors.

The network management software maps high-level business service requirements and agreements into policies that include low-level commands and management objects that configure these services. These polices show the status of network devices and the services that have been configured to run on them. Network management software maps high-level business policies to provide for better management of services delivered and handling of problem causes when services are not delivered. The network management software integrates low-level objects understood by network devices with the high-level business concepts understood at the business level of the organization.

The network management software provides tools for experts in the business and technical domains to map these two different environments into a single system. This also has the benefit of making it possible (once a service has been defined) for fewer and less-skilled individuals to manage network services.

In one aspect, the invention is a method executing network management software for managing devices on a network. The method includes mapping high level abstract objects to specific to specific vendor, model, firmware, release, or configuration-specific objects to provision and manage the network.

In another aspect, the invention is an apparatus executing network management software for managing devices on a network. The apparatus includes a memory that stores executable instructions; and a processor that executes the instructions to map high level abstract objects to specific to specific vendor, model, firmware, release, or configuration-specific objects to provision and manage the network.

In still another aspect, the invention is an article that includes a machine-readable medium that stores executable instructions for managing devices on a network. The instructions cause a machine to map high level abstract objects to specific to specific vendor, model, firmware, release, or configuration-specific objects to provision and manage the network.

The aspects above may have one or more of the following advantages. Aspects above provide a metadata-based approach to normalizing data from different sources. Other aspects provide an object-based approach to the integration of areas of fault, configuration, performance, security and accounting data. Other aspects provide hierarchical integration of customers, services, networks, devices, and fault-management, configuration, accounting, performance, and security (FCAPS) data with integration of analysis at all levels of the hierarchy.

Most systems collect and analyze data without an understanding of the relationship of parts of devices, their capabilities, and capacities and how they interrelate to business services. This results in excessive data collection, a burden to the operating components of a network and sub-optimal analysis.

The approach taken here is to have mini-analytic modules associated with key objects in the system. These objects include the devices, the elements that make the devices, and the higher level services the objects support as well as the technologies that are involved in delivering a specific service. The mini-analytic modules are associated with each of these objects in the hierarchy so that operators can be informed exactly where there is a problem and how that problem impacts customers, services and individual network components whether this problem is configuration related, capacity or performance or fault related. This approach allows for more effective, accurate and timely fault and performance reporting while at the same time reducing overall load since the system can more precisely collect the data required for analysis based on its knowledge of what services have been configured on behalf of customers and what devices and parts of these devices are used in the delivery of these services.

The approach described herein is one by which high level abstract objects/concepts are mapped to potentially many vendor, model, release, and configuration-specific objects making it possible to provision and manage a network with fewer and less skilled individuals. New devices and technologies may be incorporated into the system without modification of the base software. For example, new objects are added and are related to other objects through the tools in the system. This is accomplished by assigning metadata to the specific objects and associating with a generic form, allowing for real multi-vendor, multi-technology network and service management. The metadata that is added to each specific object in the system allows for a canonical representation of information regardless of the management access method (e.g., CLI, XML, SNMP, FILE, HTTP) The management objects, which include the metadata attributes also identify the type of management function(s) the management objects perform. This approach makes possible the identification of objects that may be used to verify correct configuration as well as verify performance levels or usage based on a specific configuration. In addition this technique allows association of service levels with actual performance, which is used for service level agreement verification.

### DESCRIPTION OF THE DRAWINGS

FIG. 1 is a block diagram of a network system.

FIGS. 2A and 2B are diagrams depicting in a table classes and components.

FIG. 3A-3F are class diagrams depicting customer associations.

FIG. 4 is a flow diagram of associating customers.

FIG. 5A-5J are class diagrams depicting technology and device associations.

FIG. 6 is a flow diagram for associating technology and devices.

FIG. 7A-7D are class diagrams depicting the devices in an object hierarchy.

FIG. 8 is a flow diagram for connecting the devices to the object hierarchy.

FIG. 9 is a class diagram for fault information associations.

FIG. 10 is a class diagram for performance and accounting associations.

FIG. 11 is a class diagram of a configuration manager.

FIG. 12 is a class diagram of knowledge modules and templates.

FIG. 13A-13J are class diagrams for a service definition.

FIG. 14 is a flow diagram of generating the service definition.

FIG. 15 is a block diagram of a computer system.

### DESCRIPTION

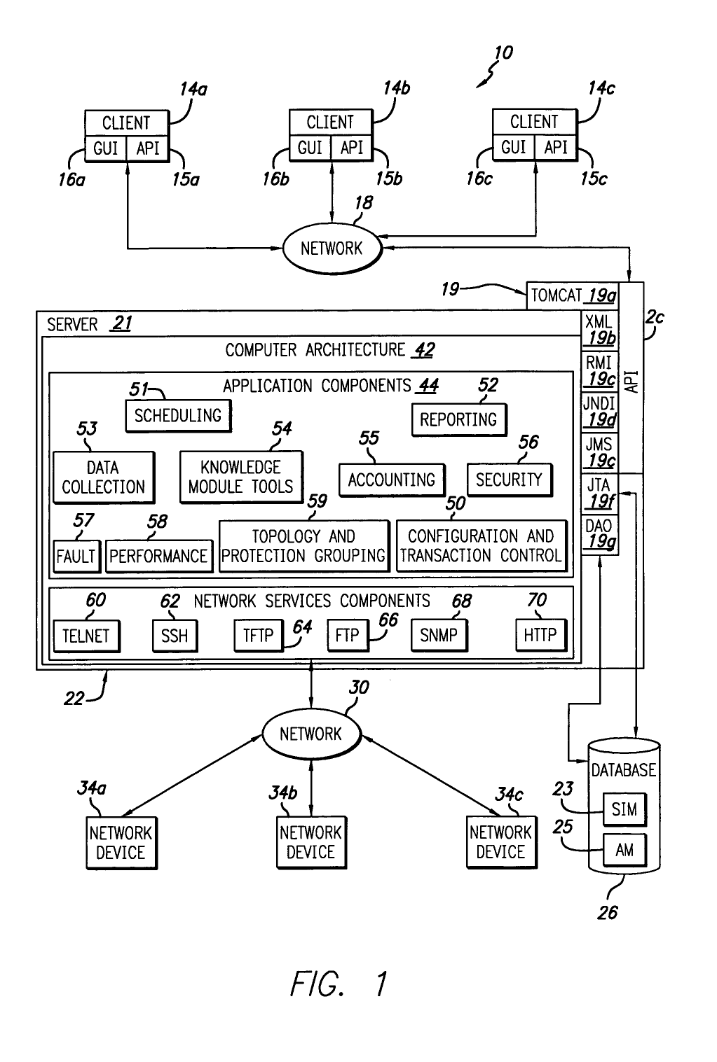

Referring to FIG. 1, a system 10 includes one or more client devices (e.g., client 14a, client 14b and client 14c), which execute a client portion of a network management application 22 (e.g., instances), a network 18, an interface 19, an application programming interface (API) 20 and a server device 21.

The client 14 may include an application programming interface (API) (e.g., API 15a, API 15b and API 15c) or a graphical user interface (GUI) (e.g., GUI 16a, GUI 16b and GUI 16c) or both. API 20 and Interface 19 (e.g., web server 19a, extensible markup language (XML) 19b, remote method invocation (RMI) 19c, Java naming and directory interface (JNDI) 19d, Java Messaging Service (JMS) 19e, Java Telephony API (JTA) 19f, data access objects (DAO) 19g) may be used separately or in conjunction to interface with server device 21, which executes network management application 22.

The system 10 also includes a database 26 that stores data used by network management application 22, a network 30, which can be the same network as network 18, and network devices (network device 34a, network device 34b, network device 34c).

Database 26 includes service information modules (SIM) 23 and analytic modules (AM) 25. For example, SIM 23 and AM 25 are XML representations of data used in system 10. Other formats can be used to input data in the system. Using SIM 23 and AM 25 are one way of modifying the data in an object hierarchy in the database 26. For example, if a vendor changes a command on a device, SIM 23 and AM 25 would be updated without changing network management application 22. SIM 23 and AM 25 are translated into a common data objects for use within the object hierarchies and stored in database 26 independent of format.

SIM 23 holds details of network devices and services to manage data separately from network management application 22. The details of the SIM 23 are used to perform functions of the network management application 22. AM 23 describes how to use SIM 23 to get a result. For example, SIM 23 may describe a command (e.g., on how to change a password). AM 25 defines operation of the command of changing the password to verify performance. SIM 23 contain definitional elements of objects as well as values (data) associated with the objects. SIM 23 may be used amongst other applications and protocols.

The database 26 may store customizations to the SIM 23 and AM 25. For example, the GUI 16 provides interfaces to those classes for presentation of results and configuration of the SIM 23 and AM 25. Also, SIM 23 and AM 25 may be directly manipulated by the Knowledge Module tools 54, for example.

The network management application 22 is a component architecture 42, which includes application components 42 and network service components 46. The application components 42 include configuration and transaction control 50, scheduling 51, reporting 52, data collection 53, knowledge module tools 54, accounting 55, security 56, fault 57, performance 58, and topology and protection grouping 59. Network services components include Telnet 61, Secure Shell (SSH) 62, Trivial File Transfer Protocol (TFTP) 64, File Transfer Protocol (FTP) 66, Simple Network Management Protocol (SNMP) 68 and Hypertext Transfer Protocol (HTTP) 70. The applications components 44 use SIM 23 and AM 25.

A user may add or configure network devices 34 to operate in network 30 by executing network management application 22. The user can access the network management application 22 on server device 21 through client 14 via network 18 using the GUI 16 or alternatively API 15. The user interfaces with the network management application 22 so that network management application 22 determines the operations to perform and reports back to the user on configuration activities or service levels. In addition, network management application 22 provides methods by which it may be integrated with other third party software systems.

As will be shown below, network management application 22 uses a hierarchy/organization of information so that fewer less-skilled individuals may manage complex networks. Details of the differences between vendors, models of equipment and software on equipment in a network along with other details that impact how this equipment is configured and monitored are also integrated into the hierarchy. This approach also makes it possible to add new devices, technologies, and vendor software revisions to the network management application 22 without, in most cases, requiring a software upgrade to the network management application 22.

Network management application 22 uses a data model that integrates management data such as fault indicators, performance reports or device configurations that makes possible more effective provisioning and verification of business services in IP environments.

Network management application 22 uses the data model for analysis of fault indicators, performance reports, security issues and other information at all levels of a network hierarchy making it possible for users to better ensure the appropriate service levels for business services and ensure conformance with stated service requirements and thus avoid customer dissatisfaction and avoid possible penalties.

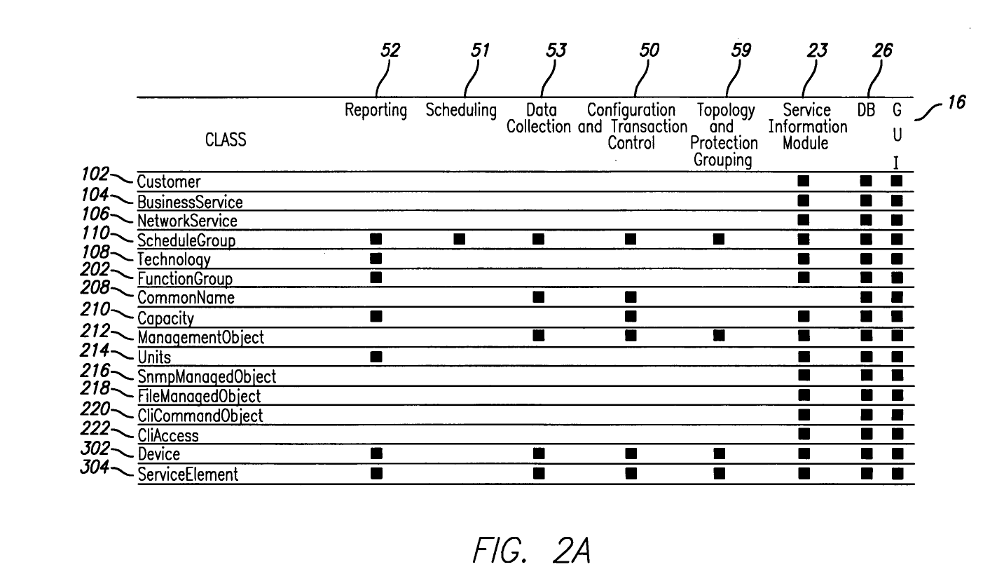

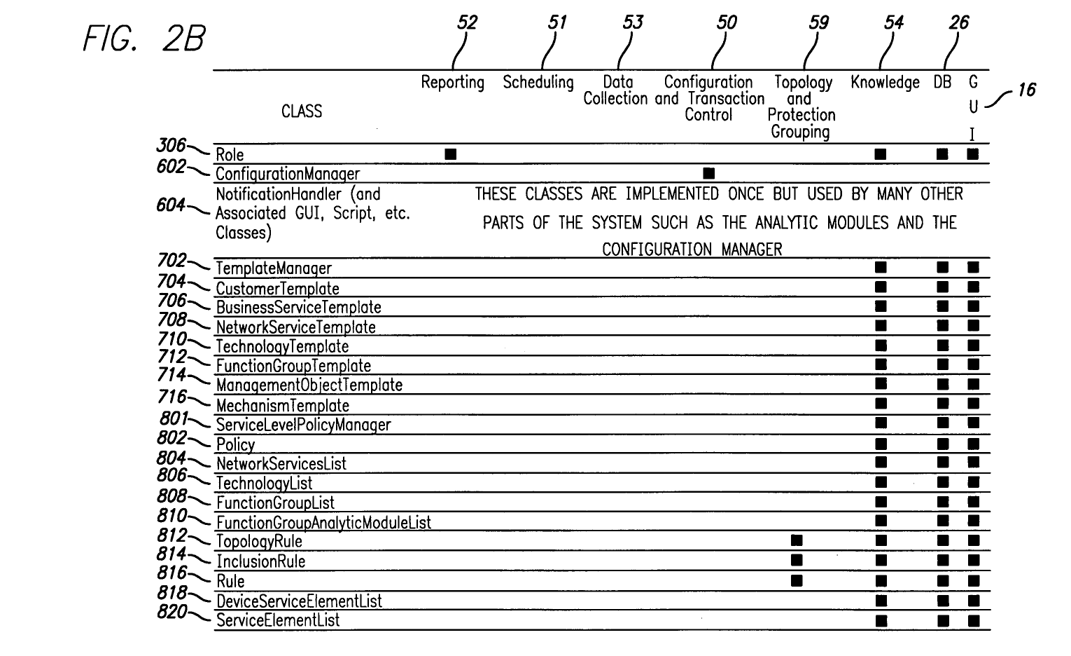

Referring to FIGS. 2A and 2B, class hierarchies are shown along with relationships of class hierarchies to application components 44 in the network management application 22.

These hierarchies are in specific software components and will be described further below.

The application components 44 shown across the first row: Reporting 52, Scheduling 51, Data Collection 53, Configuration and Transaction Control 50, Topology and Protection Grouping 59, SIM 23, Database 26 and GUI 16 represent the network management Application Components 44 that implement these and other classes. A square in a box that intersects a class and an application component 44 either implements or processes instances of data from the class.

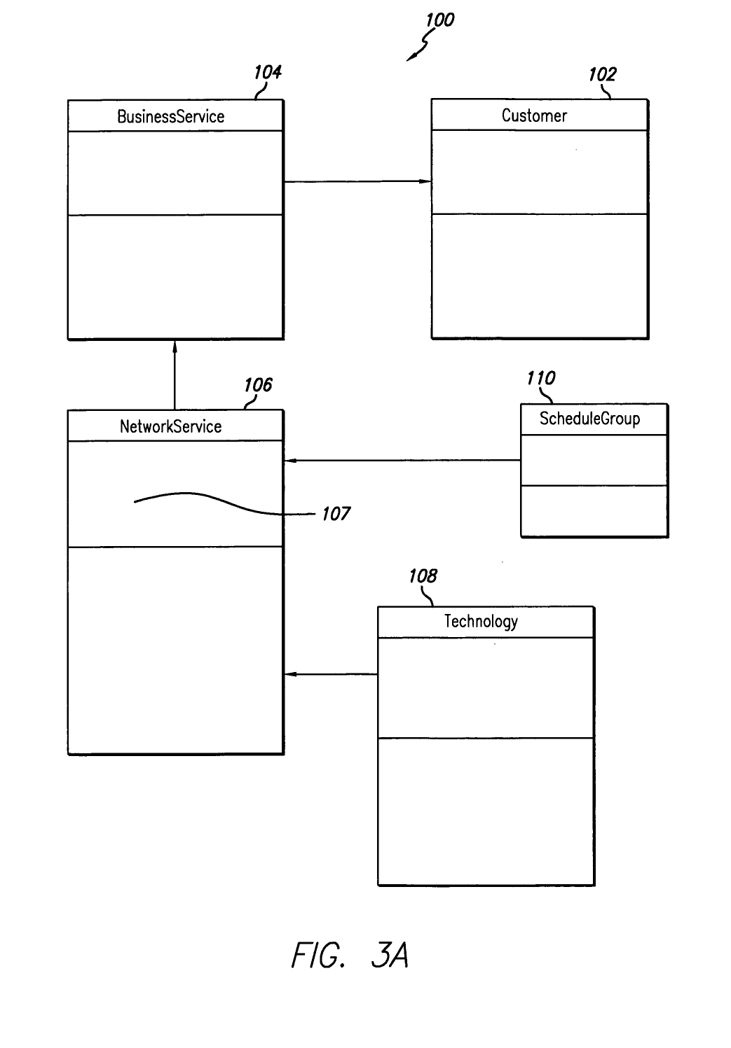

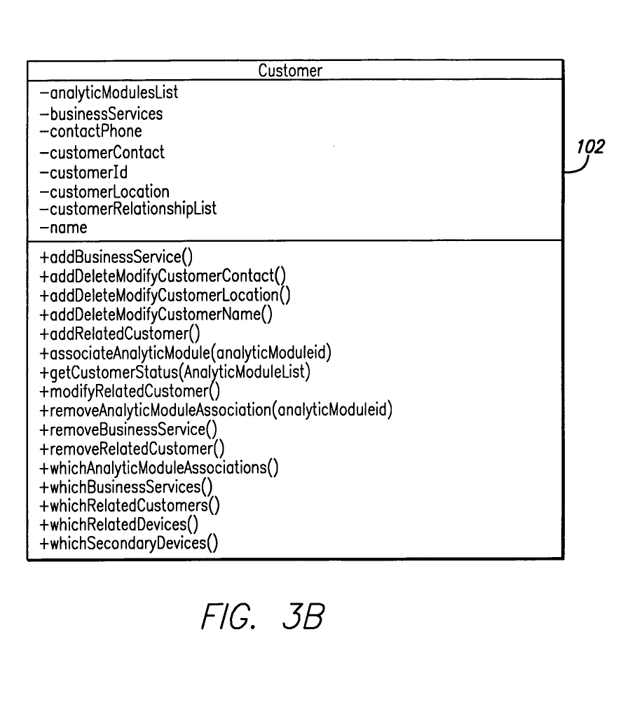

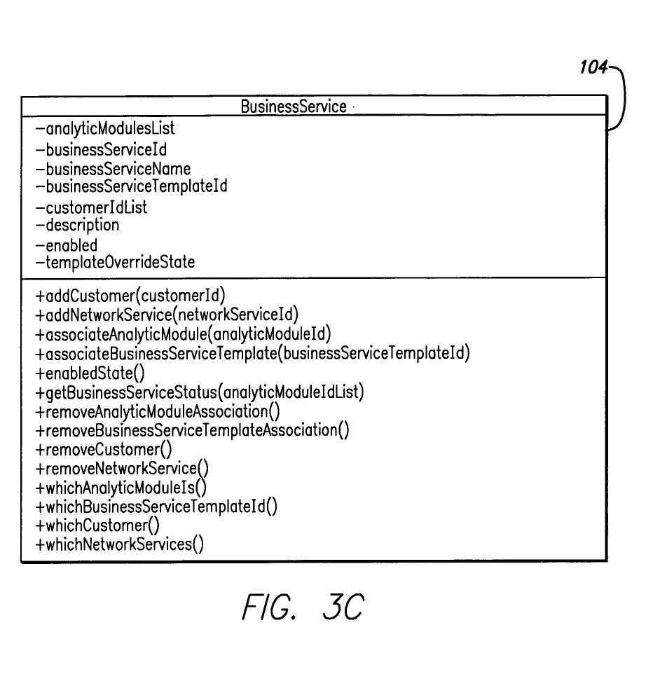

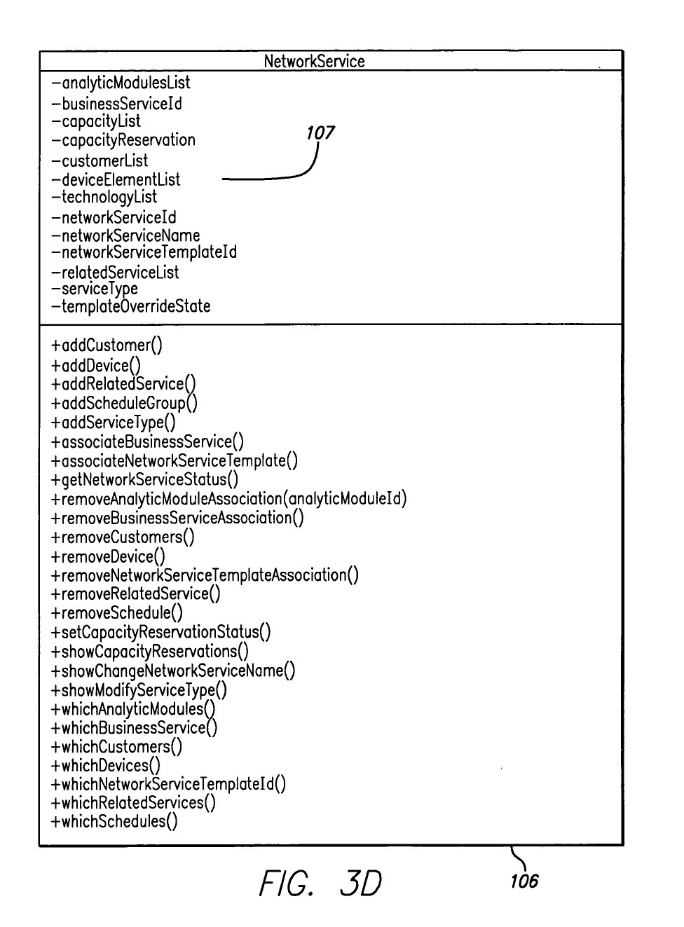

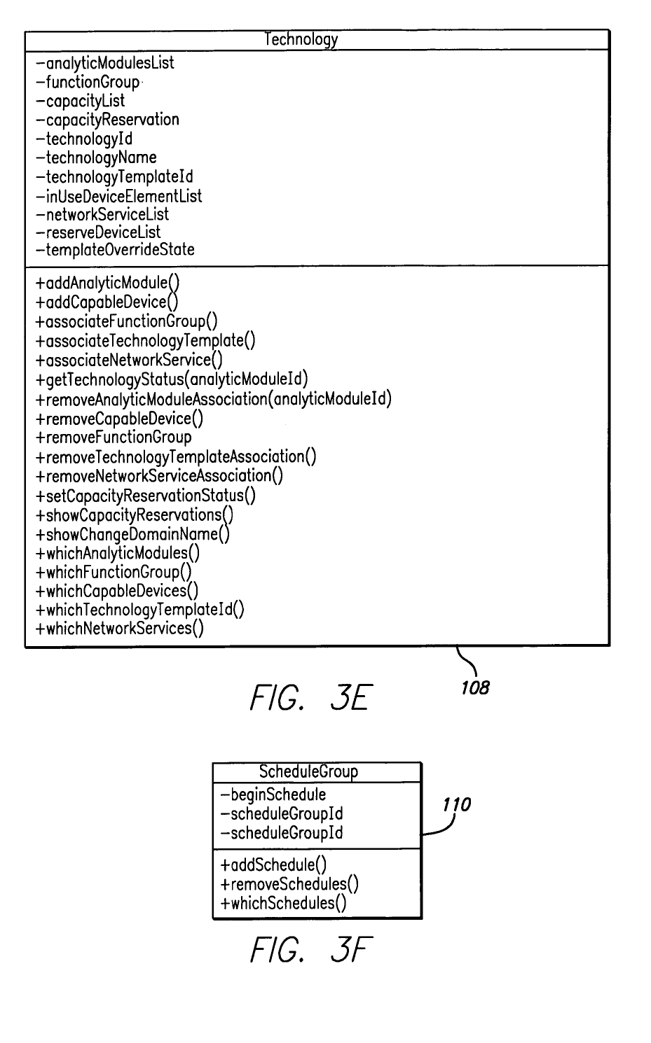

Referring to FIGS. 3A-3F, a portion of the object hierarchy 100 shows customer associations. A Customer class 102 is associated with a Business Service class 104. Business Service class 104 has associations with Network Services class 106. Business Service class 104 is a complex service that may require multiple network services to implement the service. For example, a secured web service with high performance may include a network security service, a routing service and QoS services.

Network Services class 106 is associated with a Technology class 108 and a Schedules Group class 110. Technology class 108 is a specific example of a type within a service area. For example, Technology class 108 within the Routing Services layer could be Border Gateway Protocol (BGP) or Open Shortest Path First (OSPF) router protocol.

The association of Customers with Services and Devices, is based on an association of a customer defined in the Customer class 106 with services and the technologies that support them. In system 10, a customer may be any ‘billable or track-able’ entity. Without a direct association of the users of a network service to the services and devices that provide those services, it may not be possible to accurately determine how much of a service has been used by a customer (e.g., a deviceElementList attribute 107 in the NetworkService class 106).

Moreover, it may not be possible to determine how well the service is functioning. Network management application 22 10 abstracts all these details without breaking the connection to the low-level details so that a variety of individuals can use the network management application 22 effectively. That is, less technically skilled, more business oriented users may use the GUI 16 to access higher level objects while, more technically sophisticated individuals will make connections involving the low to high level objects for the network management application 22.

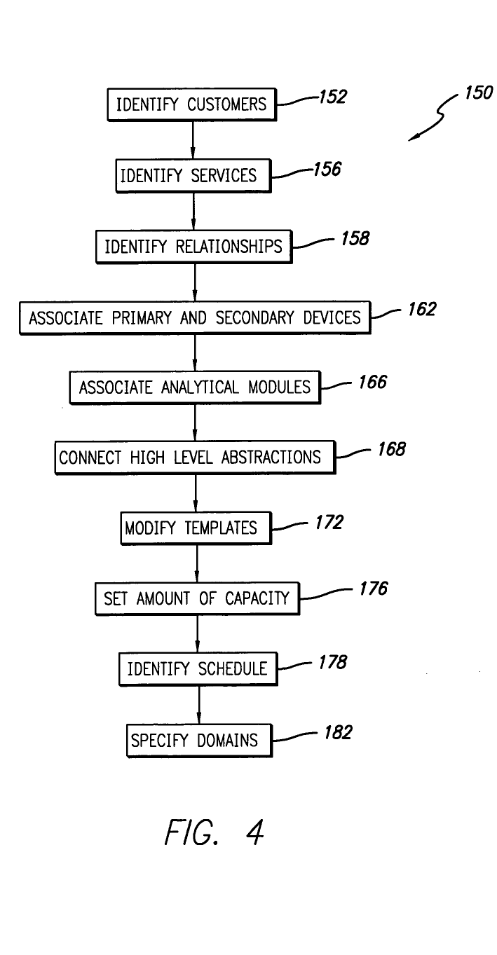

Referring to FIG. 4, a process 150 makes customer associations by identifying (152) a customer and unique characteristics such as location and contact information. Process 150 identifies (156) the services that the customer is being provided. This makes it possible to associate the service level provided to a customer through the behavior of specific services assigned to the customer. Services may be already defined and instances of the defined services are applied.

Process 150 identifies (158) relationships that the customer may have with other customers. In some examples, customers may be customers of other known customers.

Understanding these relationships is key to understanding how the functioning of a service that supports one customer may impact another. For example, if customers of a primary customer uses a web service provided by the primary customer, and the web service fails, knowing this relationship may help an operations center better deal with outages by contacting those customers of the primary customer.

Process 150 associates (162) primary and secondary devices to allow the association of the devices in the network to the customer and the services. Through this association, the impact of a failure of any component is better understood and the impact on the expected service levels of the customer. The identification of devices as being “primary” or “secondary” devices allows operators to know if a failure is likely to have impacted services or not. For example, the failure of a secondary device may not impact service if the primary continues to function. Similarly, if a secondary device is in operation also supporting the service and a primary device fails, then services may continue to operate effectively. The software through these associations may give operators information to better help with service level notifications that may be required in their service level agreements. The software through the topology functions in the Topology Manager may be set up to make these associations automatically.

Process 150 associates (166) analytic modules. The analytical modules allow the expression of service level objectives such as latency or uptime. The analytic modules follow the general hierarchy of Management Objects from the lowest level objects in a function group that are contained in a service element (such as an interface) inside a device (such as a router). These devices and service elements that have function groups that support a particular technology like differentiated services that are part of technology groups like quality of service. The analytic modules are associated in the hierarchy from the lowest level (e.g., service element and function groups) to higher levels of the hierarchy for each customer. The user may make associations of one or more analytic modules to monitor an overall performance of a network and the user may make associations to lower, level analytic modules to monitor performance of specific parts of the network. Templates for analytic modules are generated by the tools provided in the system to generate and manage SIM 23. These may be applied to any and all levels of the object hierarchy making it easier to define and modify new service instances.

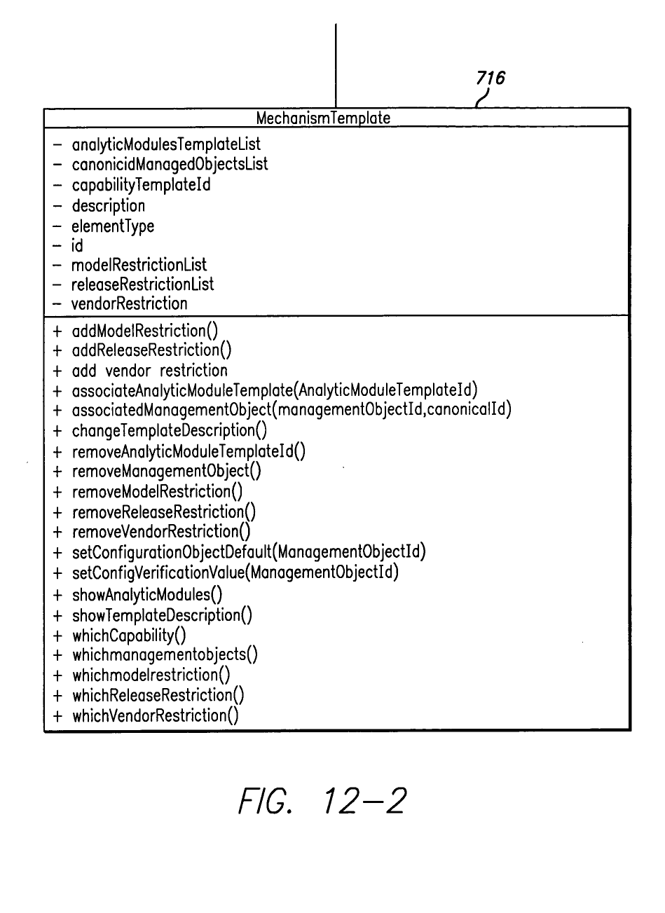

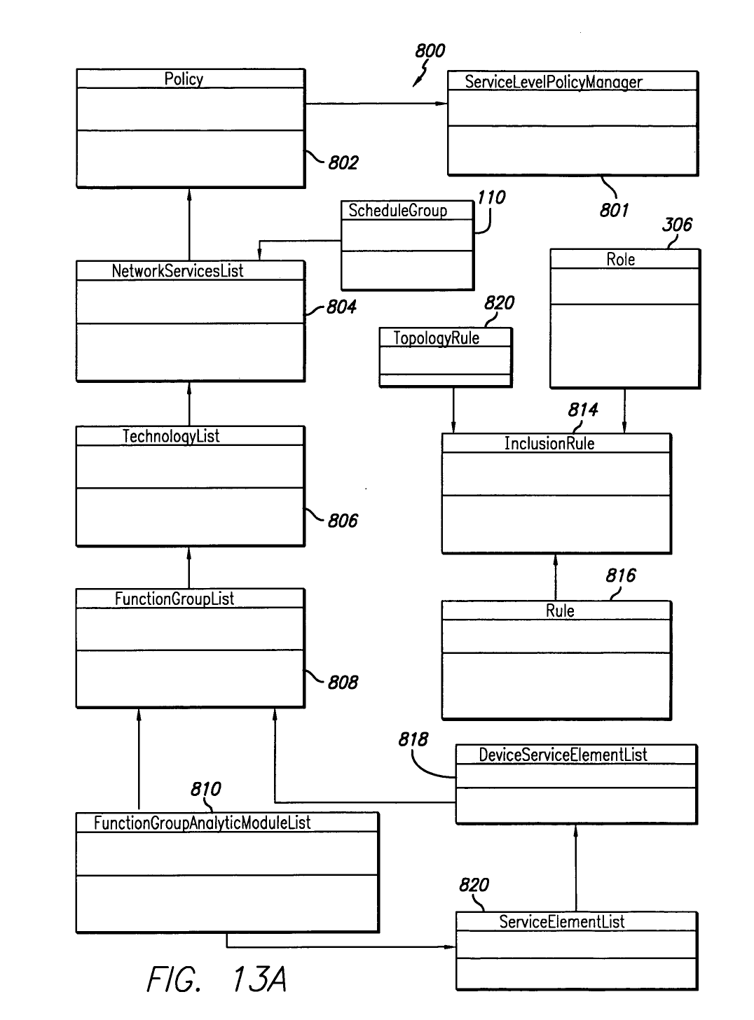

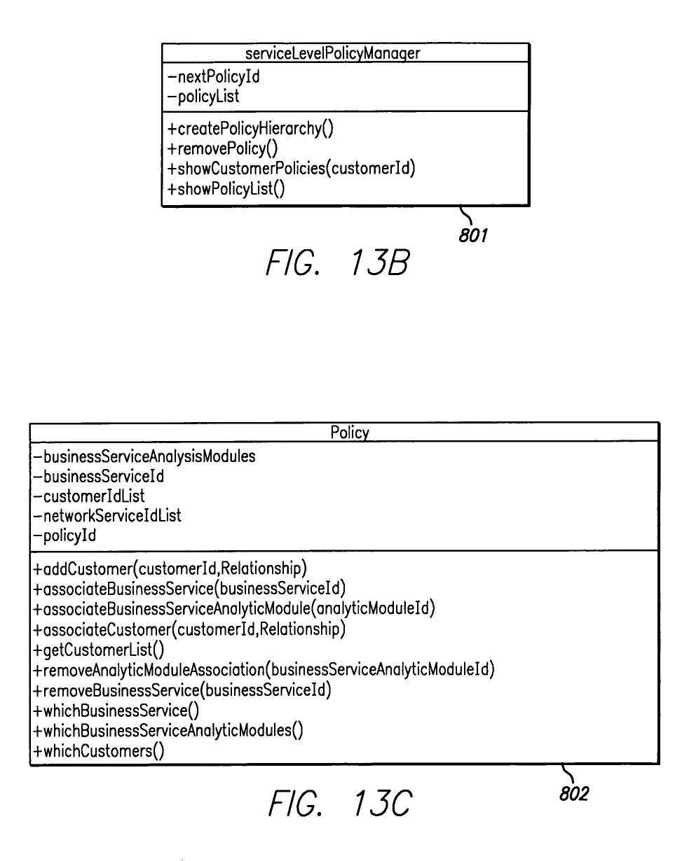

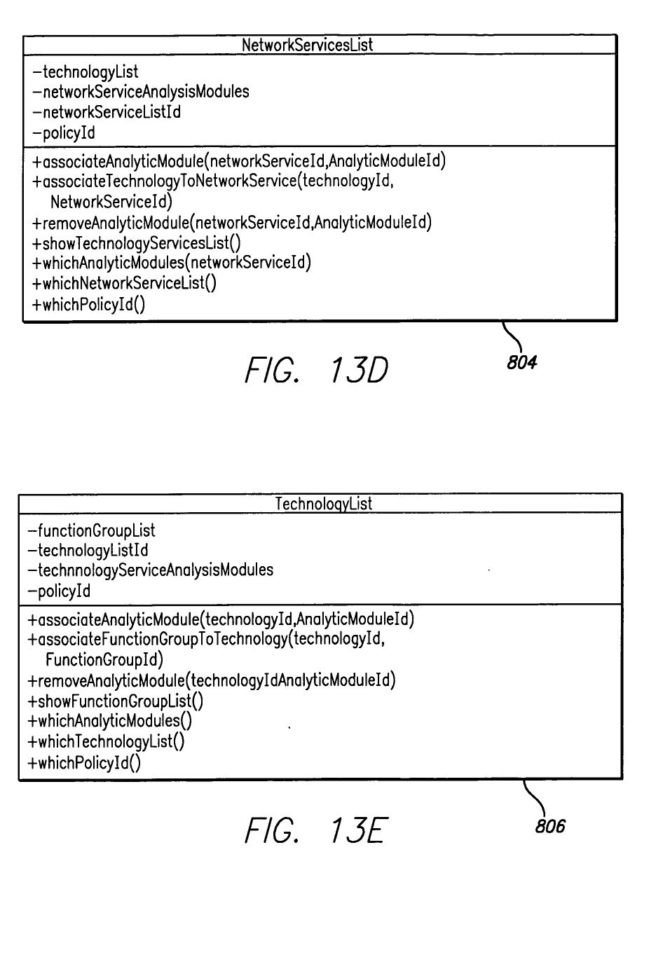

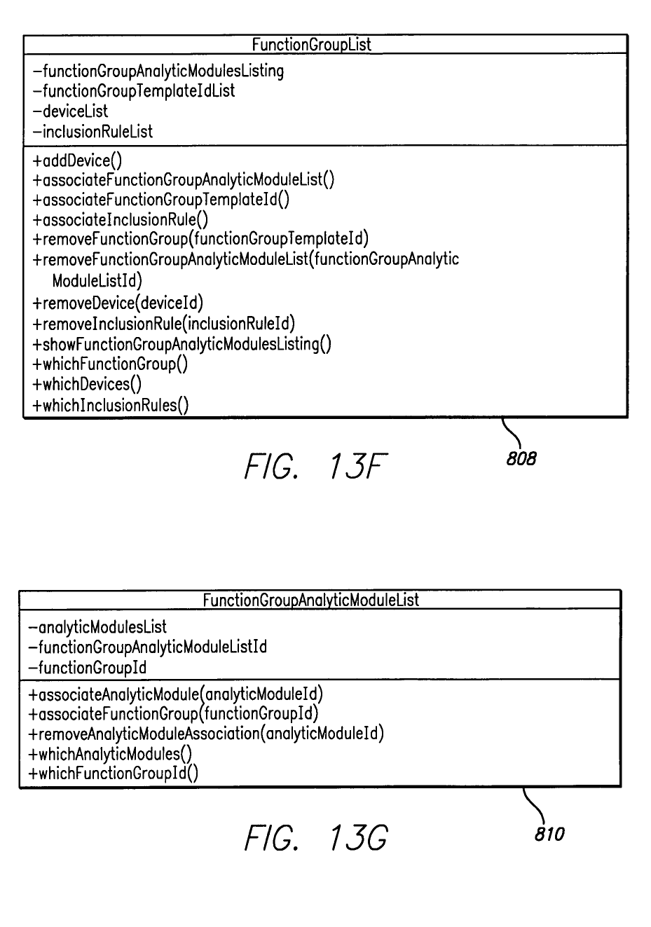

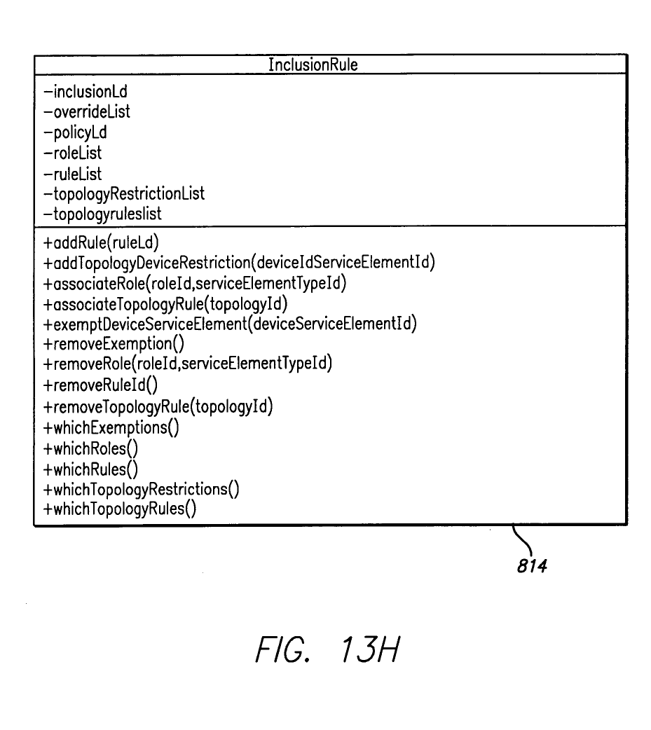

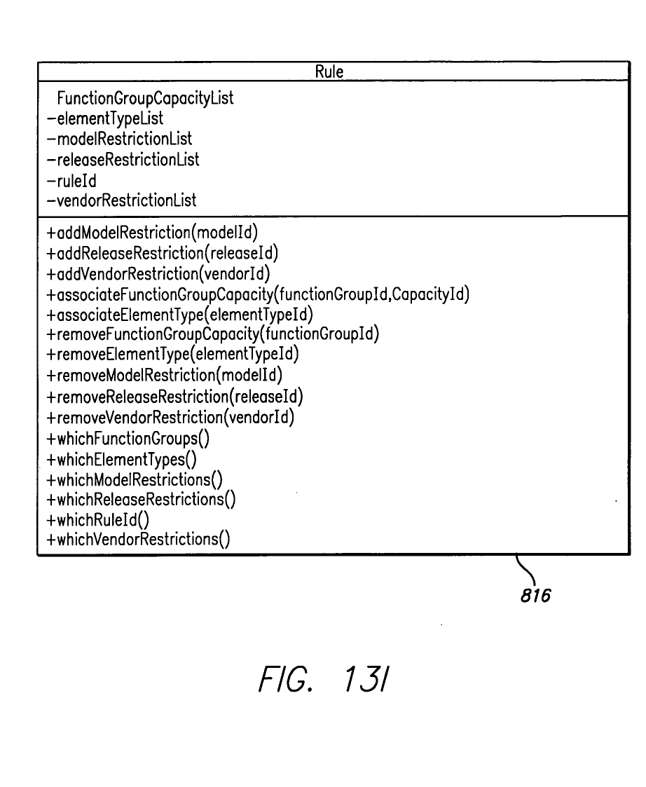

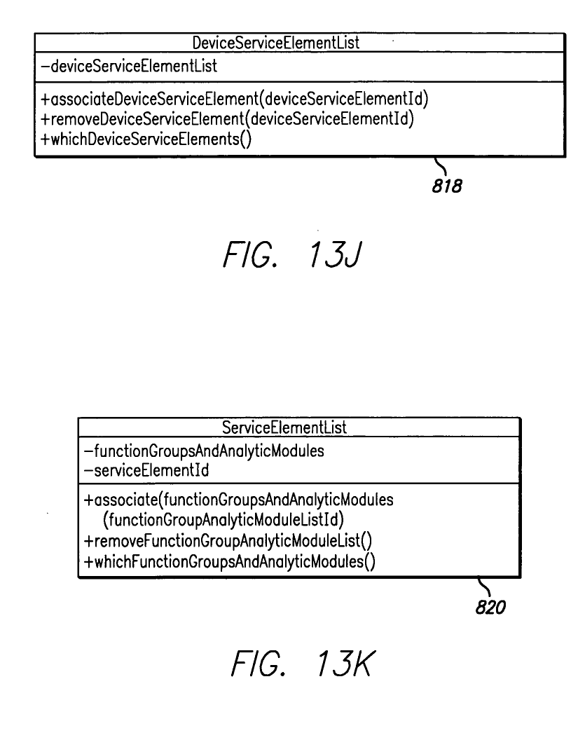

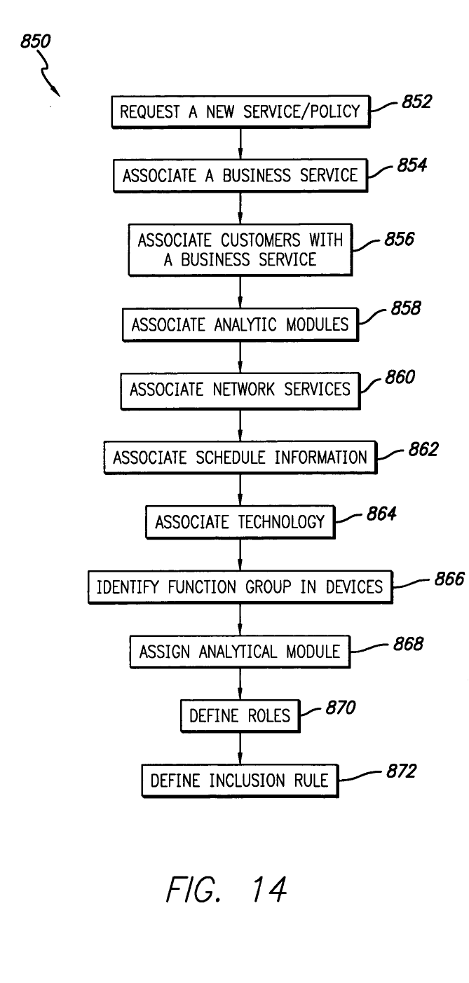

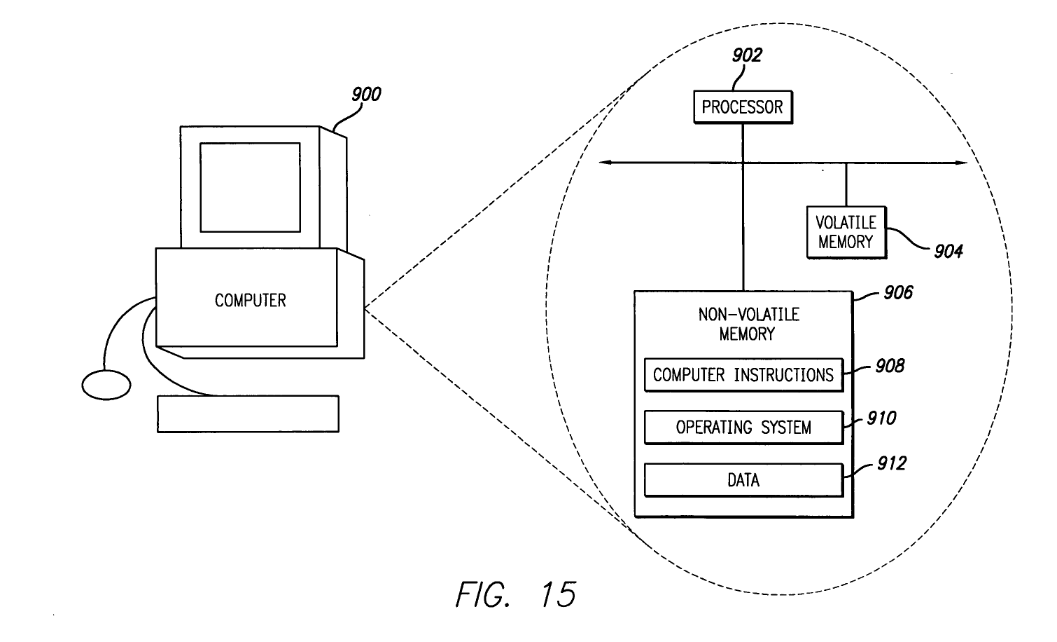

The high-level services (Business Service Policies) are made up of one or more network services such as routing services, web or security services. For the top of the hierarchy to be connected to the devices that provide such services, process 150 associates (168) the high level abstractions to increasingly more specific details, which via process 800 are connected to specific devices and the service elements they contain (FIGS. 13A and 14). The user associates the network services that would be used to provide a high-level business service. For example, if the service were secure Voice over IP (VoIP) services there would be two network services supporting the high level business service: security and Quality of Service (QoS) to ensure that the voice service met specific criteria. The specific criteria for service level objectives are contained in the associated analytic modules for each NetworkService instance. The getNetworkServiceStatus method, just like the equivalent getBusinessServiceStatus and getCustomerStatus methods in the BusinessService class and the Customer class respectively make it possible for the network management application 22 to report to the user at any time during operations, the status of a specific level of the hierarchy. In this case, the network service level.

Process 150 modifies (172) templates. If the user wishes, the user may modify the templates that make up a knowledge module or augment the templates. Process 150 sets (176) the capacity to reserve for this network service instance so as to avoid conditions where new services would be added to the network infrastructure which might oversubscribe the network elements and cause service level degradation. This same function may be used as a trigger to let operators and customers know when a specific service is about to exceed capacity thus allowing for modification of agreements or deployment of additional network resources.

Process 150 identifies (178) the schedule. Not all services are concurrently running in a network. For example, some times of the day, day or week, week of month, month of year are identified as key determinants of what services should be configured (resources reserved) or not. The user may identify the schedules for the activation of this service via association of an instance of the ScheduleGroup class 110 to an instance of the NetworkService class 106.

Process 150 specifies (182) Technology class 108. The user specifies the technology(s) that are to be used to provide a service. Domains of technology allow for the connection of high-level abstractions like Quality of Service to the devices in the network by knowing what technologies each device supports. One example would be to use Differentiated Services in a network to ensure a consistent quality of service for a specific traffic type such as Voice over IP. Once a technology is known to be supported by a device these high-level abstractions can be further mapped into the device specific objects used to configure and monitor the service.

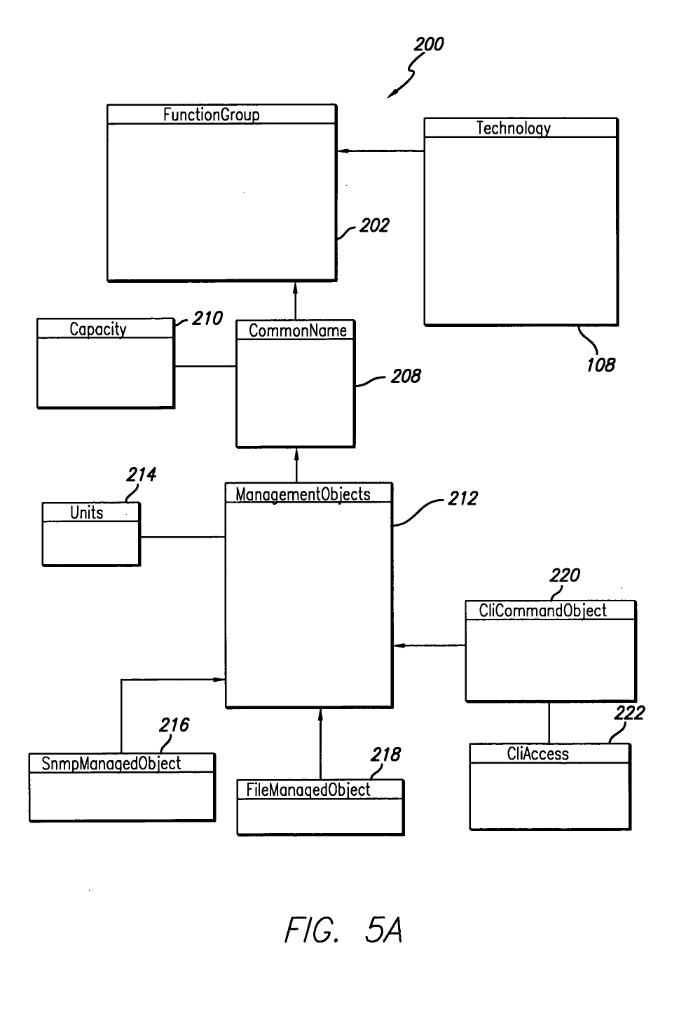

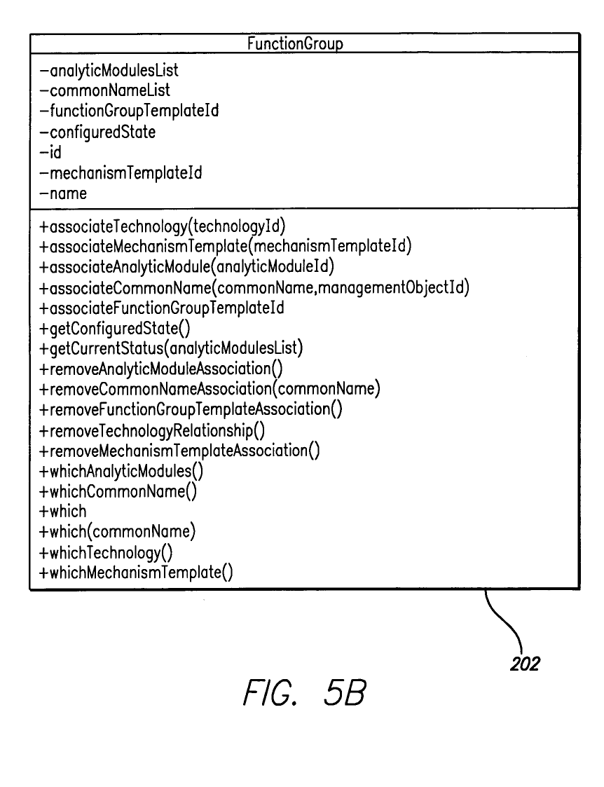

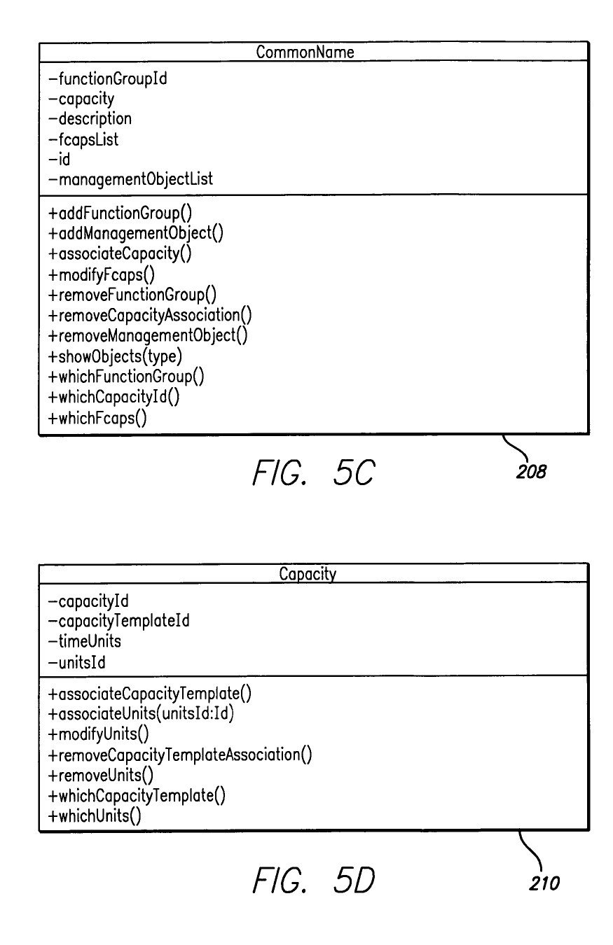

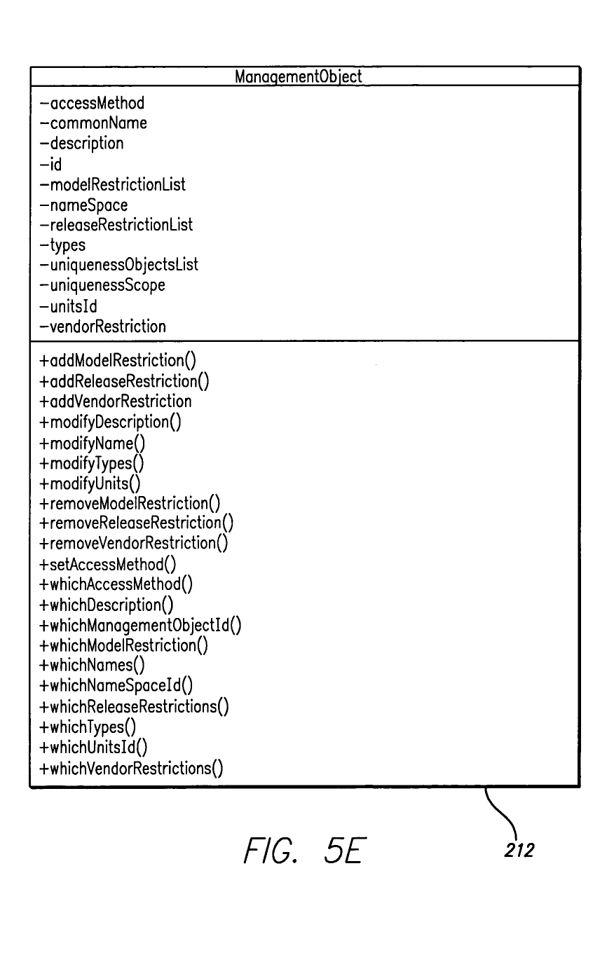

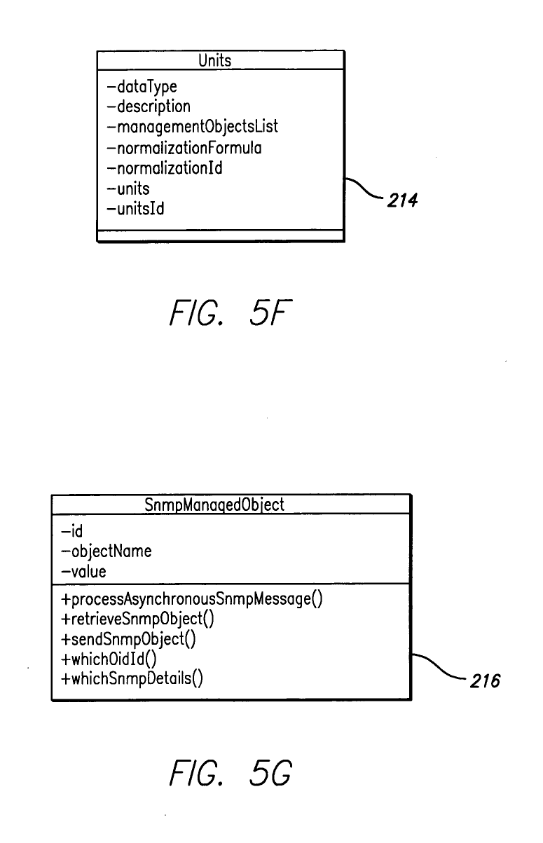

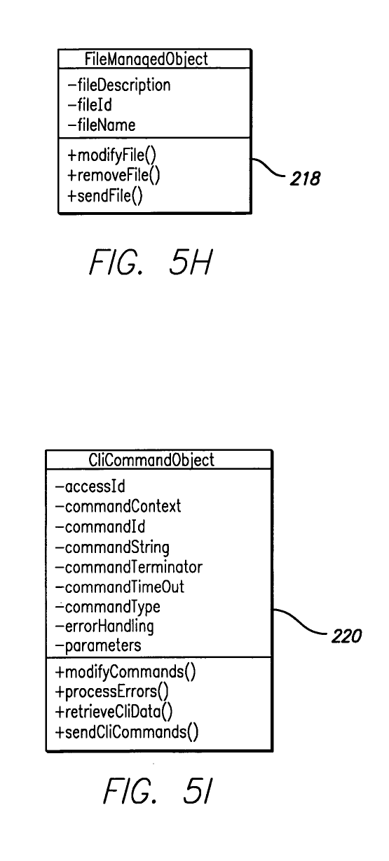

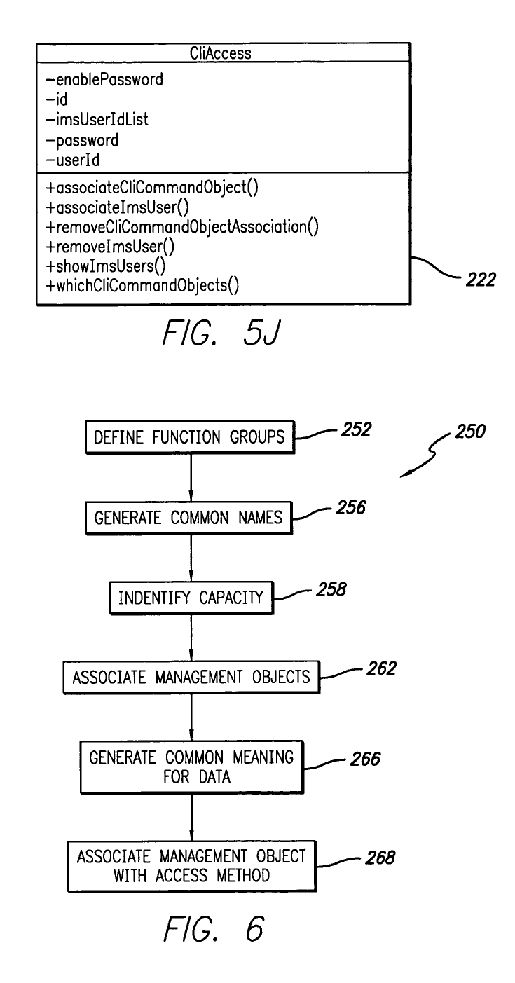

Referring to FIGS. 5A-5J, a portion of the object hierarchy 200 depicts associations of technology and device-specific details to higher level functions while hiding those details from most users. One of the main problems that exists is that management of different vendors means different sets of management objects. A Common Names class 208 (e.g., a CanonicalID class) ties different vendor, protocol, and standards-based specific implementations of objects in a Function Group class 202 to a common handle for that function/capability. This hierarchy is independent of any one of a number of external representations of the data that may be used such as XML.

The Technology class 108 connects this portion of the hierarchy to the Technology class 108. Typically, technologies such as Differentiated Services require many different mechanisms to be correctly configured and monitored. These different mechanisms are put into function groups (i.e., Function Group class 202 in FIG. 5A). Function groups class 202 are collections of related objects in a technology such as weighted random early detection (WRED) or weighted fair queuing (WFQ) in the Differentiated Service Technology.

Thus, the next level of abstraction in the hierarchy is that of Function Groups class 202. Every item within a Function Group class 202 has a common name (i.e., Common Name class 208). Common name is way of abstracting to achieve a function in a function group. Common Name class 208 is associated with Capacity class 210.

There may be many management objects (i.e., Management Object class 212) for a single common name. For example, Management Object class 212 is associated with units 214, SNMPManagement Object 216, FileManagement Object 218 and CLICommandObject 220, which is associated with CLIAccess 22.

Referring to FIG. 6, an exemplary process 250 to associate mechanisms associated with a technology to specific commands to send to devices for correct configuration is shown. Network management application 22 uses a top-down approach or defines a service information module by starting at the bottom of the hierarchy and working up to the Technology class 108 and to higher levels of abstraction. Once these associations are made, less skillful users deploy and manage services in a network since the network management application 22 will already know the associations making deployments less costly. For a given Function Groups class 202, there may be many Common Name class 208 required, because several configuration objects may be needed to set up a Function Group class 202 and several fault, performance, etc. objects may be required to manage the Function Group class 202 once set up. Since there are different vendors, access methods, and standards bodies there are potentially many instances of a Management Object class 212 associated with a single instance of a CommonName (208). These management objects belong to the same Function Groups because each Management Object is paired to a Common Name and in turn to a function group. Each instance of a Management Object is for a specific combination of vendor, model, and so forth (see the Management Object class).

Process 250 defines (252) Function Groups class 202. For example, the user would define as many Function Groups class 202 as are necessary to support a Technology class 108. For example using the Differentiated Services example, one common name would have the ability to remark a packet's differentiated services code point value as it leaves the router.

There could be one or more configuration objects needed to accomplish this. Also related to that common name would be counting the number of packets remarked in the fashion described. These would be the same common name, but to express this we would have different Common Name class 208.

Process 250 generates (256) as many Common Name class 208 as are necessary to represent the Function Group. A Common Name object may be both a performance and accounting object, but generally, for each type of function within a Function Group, there are be one or more Common Name objects required.

Process 250 identifies (258) capacity to associate with the Common Name class 208 on a per Device or ServiceElement basis. This makes it possible to monitor utilization and performance of a specific Function Group class as it relates to a pre-set capacity, for example the number of packets that could be forwarded per unit of time or number of web pages served per second.

Process 250 associates (262) one or more Management Objects with each Common Name class. Management Objects are specific to the access method (e.g., SNMP, XML, CLI, etc) vendor, model, firmware revision, and software revision. There is a large amount of metadata associated with the Management Object in network management application 22 to allow the abstraction from these low-level details to higher level abstractions like Common Name class 208 and Function Groups class 202. Examples include restrictions for the vendor(s), model(s), and releases for which a Management Object is valid. These associations need only be made once by an expert in the particular technology or knowledge area. Once contained in the network management application 22 knowledge module list, non-experts may take advantage of this information. Further, this removes the need for the experts to maintain their separate areas of expertise and then try to integrate them.

Process 250 generates (266) common meanings for data, commands and so forth used by different vendors. For example, one problem in integrating of multi-vendor systems is normalizing data from different sources. Through the use of the Units class 214, the user generates a common meaning for the data contained in a Management Object, even if it comes from vastly different sources.

Process 250 associates (268) Management Object with an access method. Once a Management Object has been generated the Management Object is associated with one, and only one access method. In the diagram the choices are CliCommandObject, SnmpManagedObject or FileManagedObject. The network management application 22 is capable of extension at this low level without causing the need to recode the higher level objects. For example, XML/SOAP could be an access method added in the future.

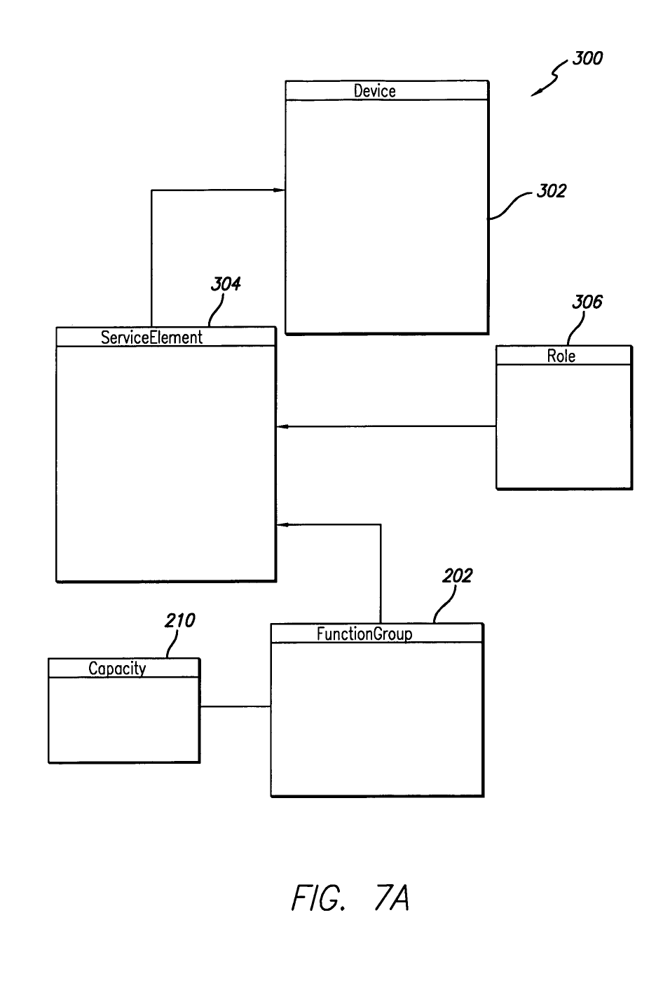

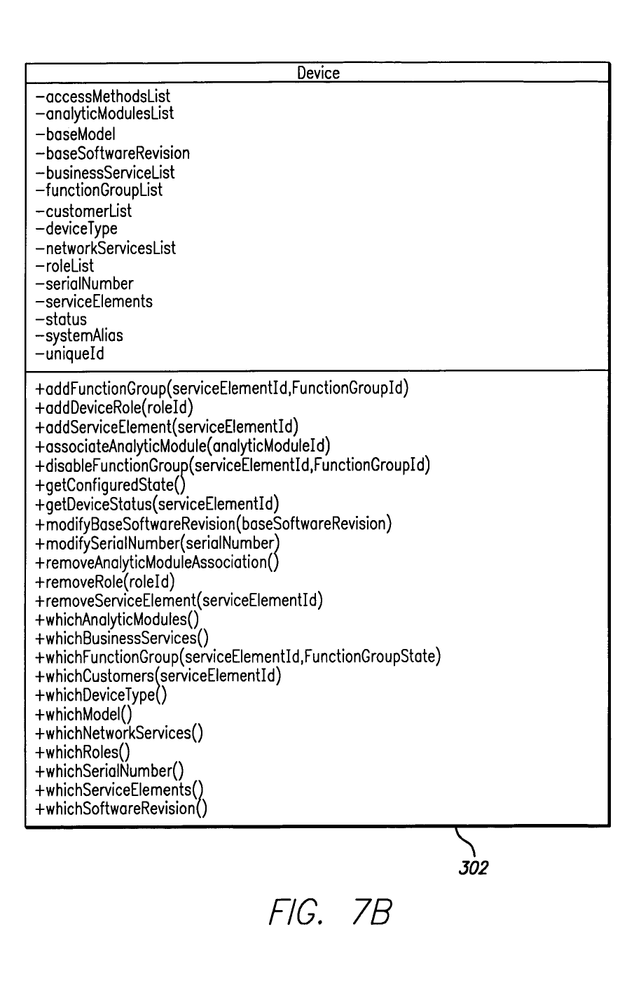

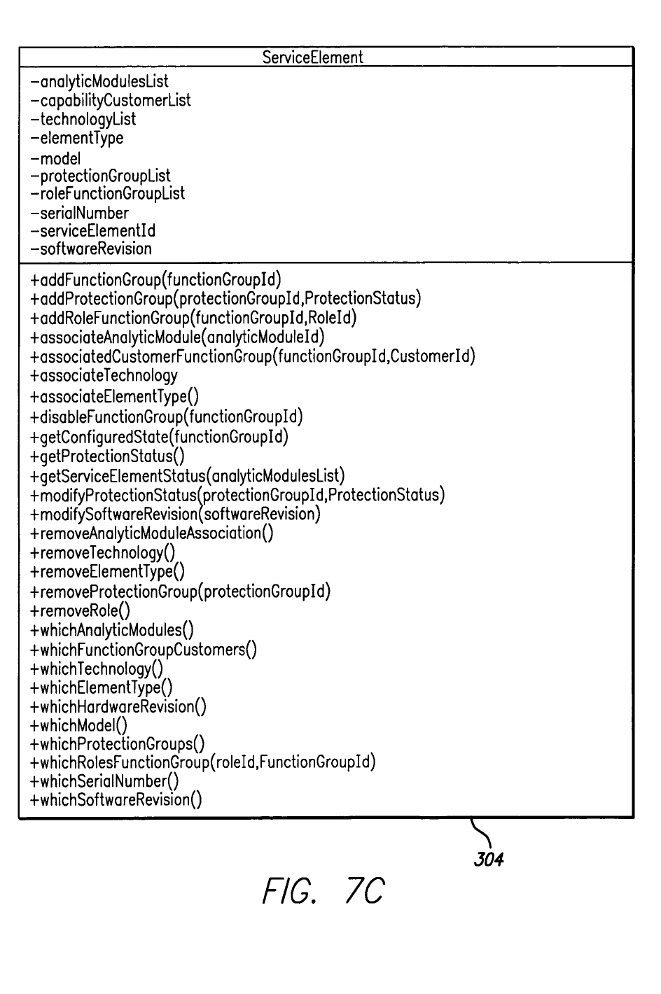

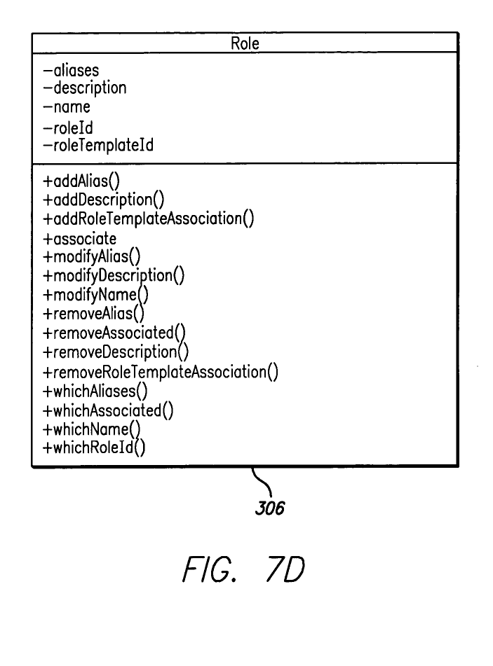

Referring to FIGS. 7A-7D, a portion of the object hierarchies 300 is accomplished via the Function Groups class 202. A Device Class 302 is associated with a ServiceElement class 304. The Service Element class 304 is associated with a Role class 306 and Function Group 306, which is associated with capacity class 210. Thus, Device objects have the concept of capacity represented in the Capacity class 210.

Each Service Element class 304 may have one or more function groups attached.

Because different functions measure what they do differently, the network management application 22 allows for the assignment of capacity to each function for each service element class 304. For example, disks measure capacity in terms of megabytes or gigabytes etc. Interfaces are measured in how many bits per second they can move or the number of a particular packet they can mark. The network management application 22 provides methods by which different values for each of these can be assigned by users or via the software.

The significance of the hierarchies in network management application 22 is how the hierarchy is used to represent a physical device in the network and how the physical device is integrated with the rest of the system 10. It is through this common class (the Function Group class 202), that devices may be ‘connected’ to the rest of the object hierarchy, which is a prerequisite to determining specific services on behalf of customers and determining which parts of those devices are critical to the services.

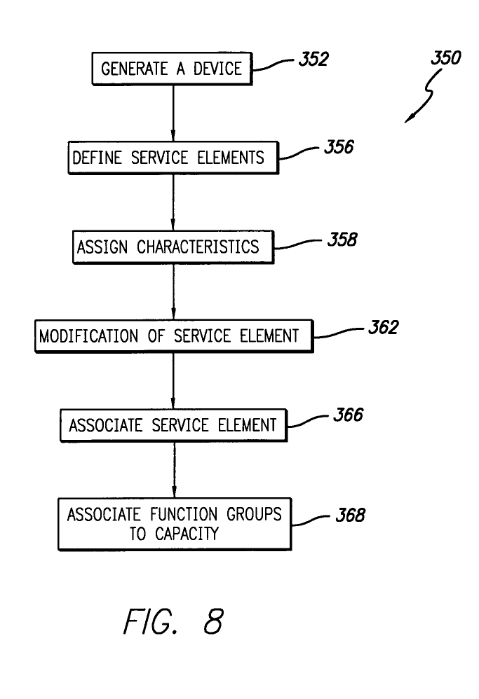

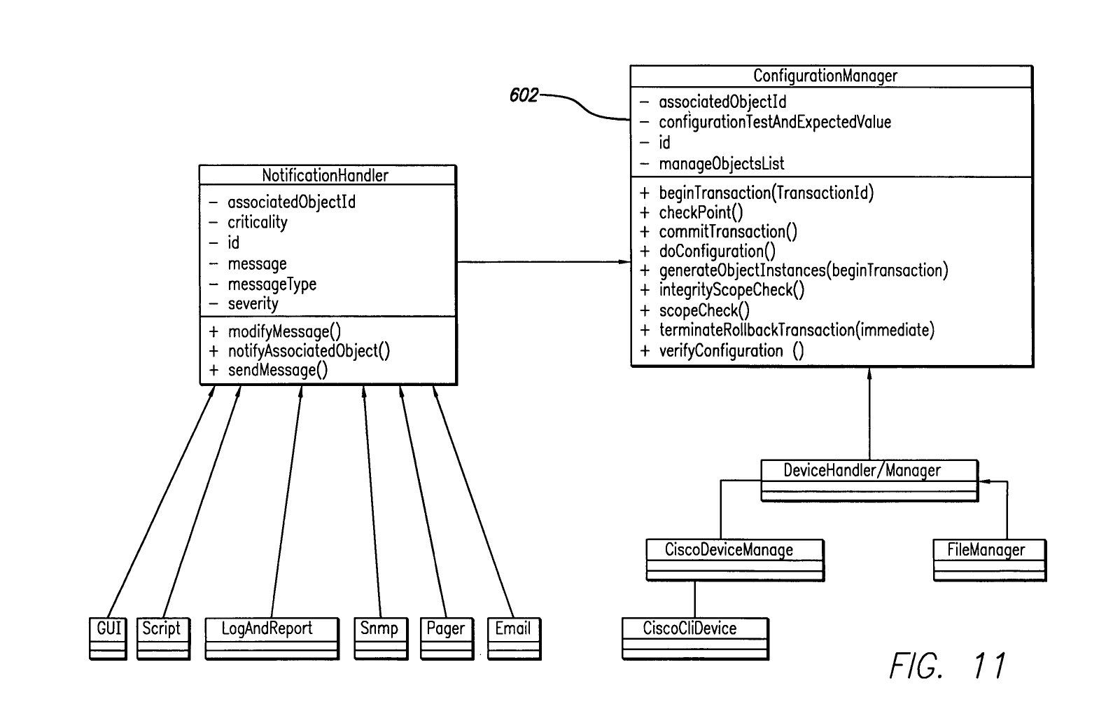

Referring to FIG. 8, process 350 is an exemplary process for allowing discovery of network devices, e.g., the discovery of the internal structure (hardware and software) and configuration of a device. The network management application 22 allows for discovery of network devices, the ServiceElements that are contained in each device and the Capacity for each Function Groups class 202 discovered on a ServiceElement (FIG. 1). Role and Rule objects are used by network management application 22 when selecting objects for inclusion in a policy/service definition (FIG. 11). In some examples, the network management application 22 may discover capacities or these capacities are inferred. Over time, capacities may be determined based on observed performance. Users may also assign capacities in each function and in each service element where they exist.

Process 350 generates (352) a device entry in the network management application 22. For example, a user fills-in details about vendor, model, release, and so forth. In other example, these information details are available from the discovery process.

For each Device, process 350 defines (356) ServiceElements class 304. ServiceElements class 304 may contain other ServiceElements, as would be the case if there were an interface card with multiple ports.

Process 350 assigns (358) characteristics. Each service element may have zero, one or more Role associations. As opposed to many of the other attributes, discovered by the software, Role is designed to allow operators to assign characteristics to ServiceElements class 304 that are generally not known to the software, but which may be important in determining if a ServiceElement class 304 is to be part of a policy. The Role object lets the user hand-define these special relationships that may then be used by the InclusionRule for a service to apply policy appropriately to ServiceElements. In the network management application 22, groups of devices and/or service elements can be collected together (as in a policy) and lists of these devices or service elements can be manually edited. These resulting lists can have actions performed on them such as assignment of one or more roles.

Process 350 modifies (362) a service element. For example, during the normal device discovery process, many of the capabilities of each ServiceElement class 304 on a device are automatically learned. The modification of this information or generation and assignment of one or more Function Groups objects to a ServiceElement class 304 for those function groups that were not discovered by the software.

Process 350 associates (366) service elements. For each Device class 302, ServiceElement class 304, and Function Groups class 202, it is possible to associate one or more analytic modules. This makes it possible to instantly have the network management application 22 report a failure at whatever level of the hierarchy the failure occurs. More importantly, when a low-level failure is detected by an analytic module, the impact of that failure of customers and the higher level services may be more readily determined.

Process 350 associates (368) Function Groups class 202 to capacity. Each Function Group class 202 may include an associated Capacity object. The user sets the capacity allowed for the associated element in the system 10 for Function Group class 202 on a device 302. In some cases, the discovery software determines the Capacity object to use. Even in those cases, users may override these automatic values to ensure that resources do not become over-utilized.

Each device and service element in the system 10 associated with one or more function groups. In some cases, the system can fill in or calculate the capacity or the user will input the capacity. In some cases, the user can change a capacity overriding a calculation. In some cases, the user can assign a capacity for a type of a function group that is found on many service elements or devices. Users can specify when creating a policy how much capacity for each type of function group is required globally or in a per customer basis. The system keeps track of how much capacity has been reserved for each user and/or service and how much remains available for a specific service element. When a new business service policy is to be deployed, the system can inform the user about potential over-utilizations.

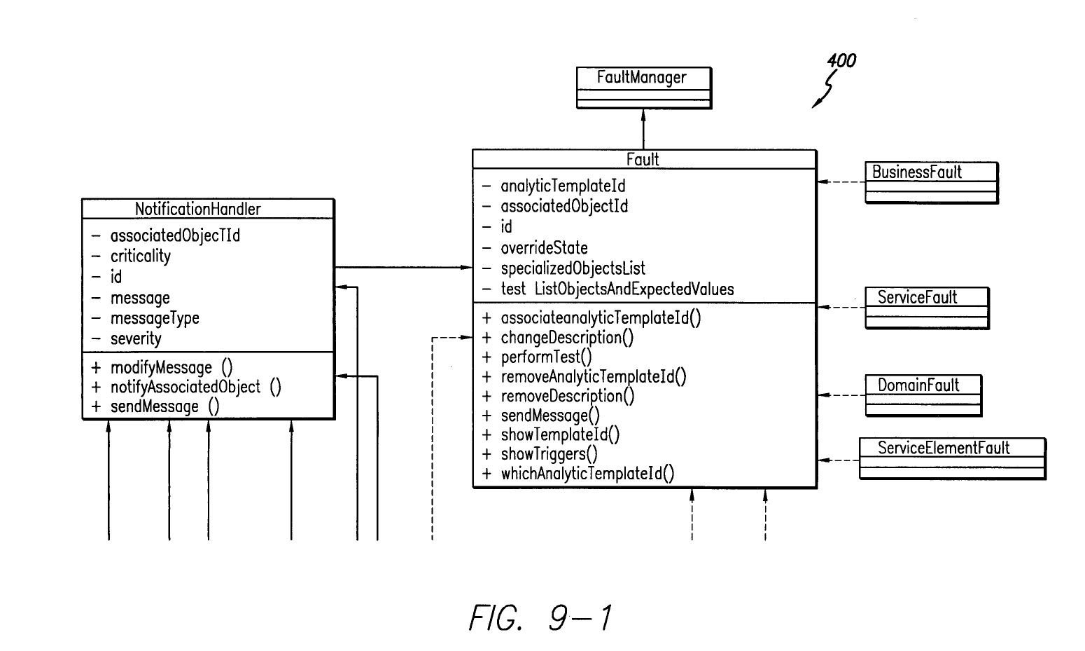

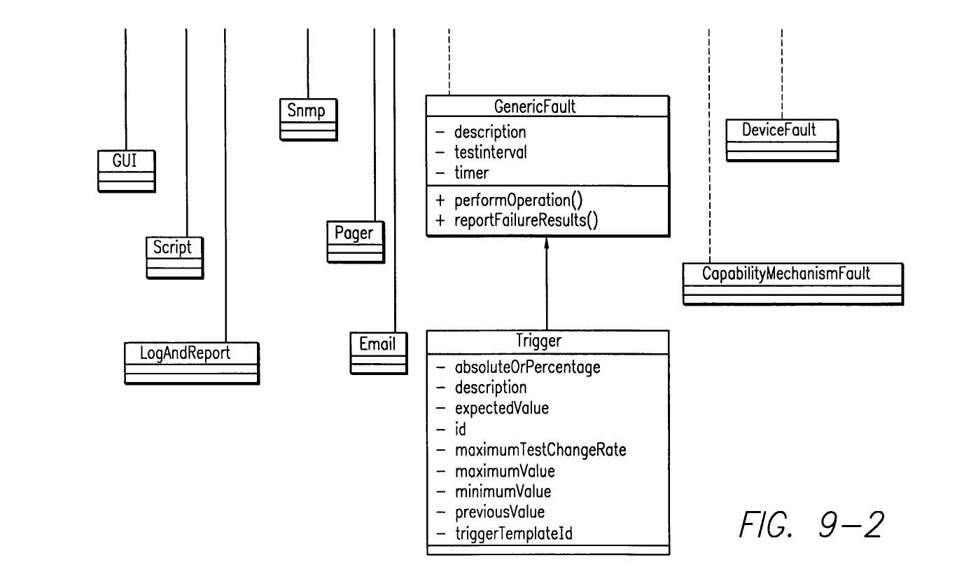

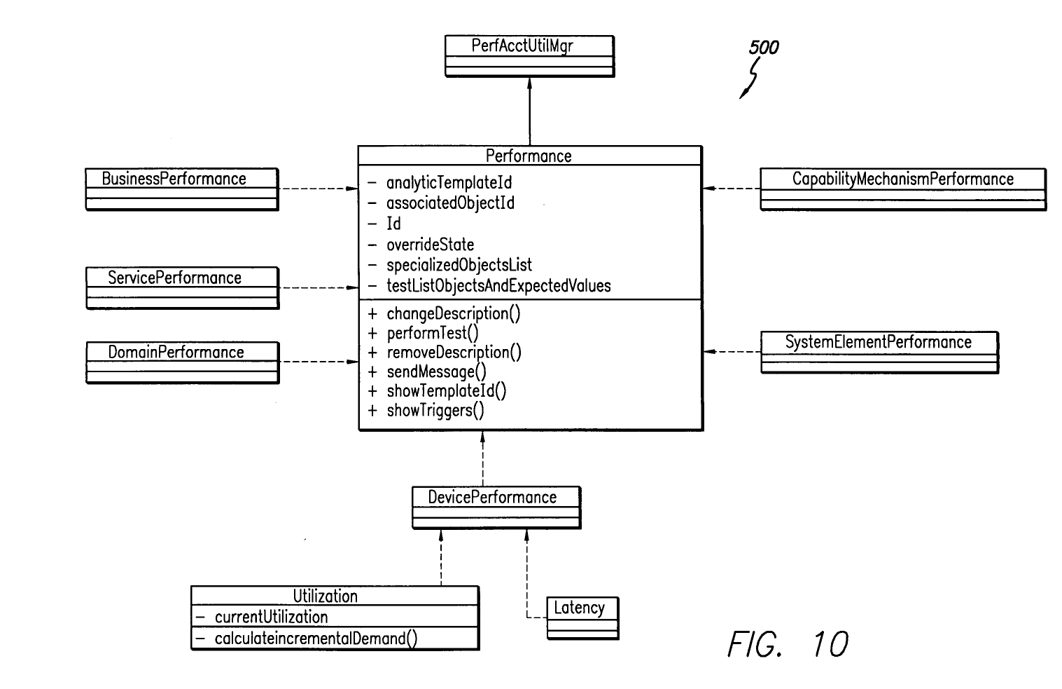

FIGS. 9 and 10 show connection of fault and performance information with a Fault Manager class 400 and a Performance class 500 with all levels of the hierarchy in the previous diagrams from the BusinessService to Function Groups class 202—(see the associatedObjectID attribute in the fault and Performance classes). The structure of the analytic modules that are in part shown in FIGS. 9 and 10 are similar for each of the analytic modules shown in FIG. 1.

FIG. 11 shows separation of the configuration software from the ‘knowledge’ of what is being configured. For example, a separate software module, ConfigurationManager class 602, performs configuration functions without knowing the details of the data or communication mechanisms used to interact with the network devices. Those details are left to the lower level software.

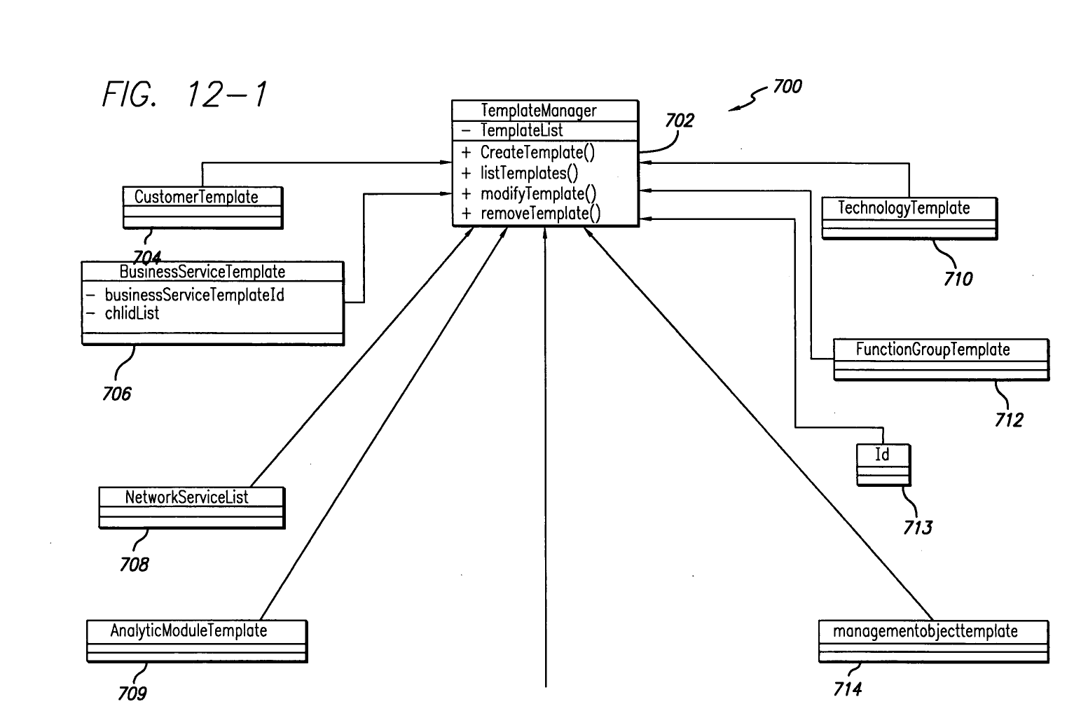

FIG. 12 shows templates used in network management application 22 10.

TemplateManager 702 includes a Customer Template 704, a BusinessService Template 706, a Network Service 708, an analyticalModule Template 709, a Technology Template 710, a Function Group Template 712, Identification 713, a Management ObjectTemplate 714, and a MechanismTemplate 716. Values in the templates are copied by the network management application 22 and applied appropriately.

A basic customer definition can be stored in Customer Template 704 and used to generate additional customers. A Business Service Policy may be generated in BusinessService Template 706 and copied and modified for use elsewhere. Network services are generated using Network Service template 708. Analytic Module are generated using analyticalModule Template 709, technology is generated using Technology Template 710, function groups are defined Function Group Template 712.

Management Object Templates 714 are used by many different policies and depending on how new business service policies are defined, a change in the base template can propagate to all the managed systems under control of a Business Service policy generated and the user indicates that they did not wish such linkage, a change in the Management Object Template(s) 714 originally incorporated into the Business Service Policy will not cause a change.

FIG. 13A-13J shows a service policy. A ServicePolicyManager 801 is associated with a Policy class 802. The Policy class 802 is associated with a Network Services List 804 and the Schedule Group 110. The network List is associated with a Technology List 806 which is associated with a Function Group List 808. The Function Group List 808 is associated with a Function Group Analytic Module List 810, which is associated with a Service Element List 820; a Device Service Element List 818, which is also associated with the Service Element List 820; and an Inclusion/Exclusion Rule 814. The Inclusion/Exclusion Rule includes Rule 816, Role 306 and a Topology Rule 820. Users may apply existing templates and pre-defined knowledge modules to deploy services for users.

The ServiceLevelPolicyManager 801 generates services in the network management application 22. The ServiceLevelPolicyManager 801 also manages the collection of services and associated information that together are called policies. A policy is a hierarchy of related information generated by a user. Policy generation and subsequent management of an existing policy is accomplished through the GUI 16 or by API 15. Both these methods access the network management application 22 through the upstream interface component shown in FIG. 1.

Referring to FIG. 14, a process 850 defines a policy. Process 850 requests (852) a new service/policy. Process 850 optionally associates (854) a Business Service class 104 with the policy.

Process 850 associates (856) one or more customers with the Business Service class 104. Process 850 associates or modifies (858) analytic modules associated with the Business Service class 104. Process 850 associates (860) one or more network services with the Business Service class 104. For each of these network services it is possible to remove or modify analytic modules associated with the network service. One or more network services are defined if there is a Business Service class 104 defined in the policy. Process 850 associates (862) schedule information (i.e., the ScheduleGroup Class 110 in FIG. 4) with the network service. This allows the network management application 22 to control exactly when the services are configured in the network and controls the collection of information about how the service is performing.

Process 850 associates (864) one or more technologies with each NetworkService.

Technologies are grouped into technology groups so that a user can select a technology group and then select from that technology group as many technologies. A network service in the context of a BSP is generated by the user by selecting from an existing technology group or generating a new one by selecting one or more technologies from that technology group. For each technology group, the user may use management object templates that have been already generated for that technology group. Each management object template includes values filled in form the management objects that are appropriate to a specific set of localization data (i.e., works for a specific vendor, model, access method (e.g., CLI or SNMP) operating software revision, hardware configuration and firmware). The smallest number of Management object templates needed are generated. That is to say, that if one works across many different systems, the least/greatest common denominators are known by network management application 22 and the smallest number are generated.

The values in the management object templates defining network services as high or low quality of service, for example. With each Technology, it is possible to associate one or more analytic modules.

Process 850 identifies (866) what functions groups in devices and the service elements they contain in the network are required to support a specific technology in a network service. For each Technology (an area of technology such as Differentiated Services in a Network Service) there are a number of function groups that are required to support the service. These function groups are the specific mechanisms that are tuned and monitored and are specific to each technology.

Process 850 assigns (868) assign one or more analytic modules to each Function Groups class 202 that are used to monitor function of the common name on a specific instance of a service element (such as an Ethernet interface) in a device

Process 850 defines (870) the roles. For example, the user may define roles that have been assigned to ServiceElements that may be evaluated before including a ServiceElement in the policy under definition. Roles may be any arbitrary string that represent a selection criteria important to the user such as an interface whose traffic might require additional security since it is facing outside the enterprise.

Process 850 defines (872) inclusion/exclusion rules. For example, users may define an Inclusion/Exclusion Rule that includes one or more rules that aid in the system's selection of eligible devices to apply the service to. In another example, some policies might only be applied to Web servers and others to routers. In some cases a policy might be applied to several different types of devices.

Once the processes are completed, the network management application 22 implements the policy and monitoring service levels at the assigned times.

During the definition process, users may generate one or more of the templates that are used in the service generation process. Templates are lists of defaults to be used for any BusinessService, NetworkService, Technology, Function Groups class 202, AnalyticModule, ScheduleGroup, Role, or other element required for operation.

FIG. 15 shows a computer 900 for managing a network. Computer 900 includes a processor 902 for managing a network, a volatile memory 904, and a non-volatile memory 906 (e.g., hard disk). Storage medium 906 stores operating system 910, data 912, and computer instructions 908 which are executed by processor 902 out of volatile memory 904 to perform one or more of the processes described herein.

The process are not limited to use with the hardware and software of FIG. 15; the processes may find applicability in any computing or processing environment and with any type of machine that is capable of running a computer program. The processes may be implemented in hardware, software, or a combination of the two. The processes may be implemented in computer programs executed on programmable computers/machines that each include a processor, a storage medium/article readable by the processor (including volatile and non-volatile memory and/or storage elements), at least one input device, and one or more output devices. Program code may be applied to data entered using an input device to perform the processes and to generate output information.

Each such program may be implemented in a high level procedural or object-oriented programming language to communicate with a computer system. However, the programs may be implemented in assembly or machine language. The language may be a compiled or an interpreted language. Each computer program may be stored on a storage medium (article) or device (e.g., CD-ROM, hard disk, or magnetic diskette) that is readable by a general or special purpose programmable computer for configuring and operating the computer when the storage medium or device is read by the computer to perform the processes. The processes may also be implemented as a machine-readable storage medium, configured with a computer program, where upon execution, instructions in the computer program cause the computer to operate in accordance with the processes.

The process is not limited to the specific embodiments described herein. For example, the processes may be performed on the Internet or on a wide area network (WAN), a local area network (LAN) or on a stand-alone personal computer.

The process is not limited to the specific processing order of FIGS. 4, 6, 8 and 14. Rather, the blocks of FIGS. 4, 6, 8 and 14 may be re-ordered, as necessary, to achieve the results set forth above.

Server elements such as the database and analysis modules may be on one or more server platforms. The system is capable of having more than one user active at one time, either directly connected to the server or over the network. That is, the instances of the Graphic User interfaces may be running locally or over the network communicating with the server system. It in turn communicates with network elements via the network service components. Network management software may be distributed across many computers for performance reasons.

In some examples, server device 21 may be replaced with multiple server devices. In some examples, a client device 14 may execute multiple instances of the network management application 22 or instances may occur over multiple client devices.

In some example, Schedule Group 110 may be associated with the Business Service Policy (BSP) instead of Network Service Elements. In addition several BSPs are collected together into a Policy Group and each policy in the Policy group can have a separate schedule.

In some examples, object hierarchies may be represented in network management application 22 using XML. For example, one implementation is:

```
- <TechnologyOSIM Name=“New network service” Description=“Security”
      xmlns:xsi=“http://www.w3.org/2001/XMLSchema-instance”
      xsi:noNamespaceSchemaLocation=“http://localhost:8080/IMSWebApp/TechnologyGroup.xsd
      ”>
  <LocalizationData Name=“Generic Localization for Cisco” Description=“Global Localization
        Data in this OSIM” FirmwareRestriction=“” ModelRestriction=“”
        VendorRestriction=“Cisco” ReleaseRestriction=“10.0 - *” AccessMethod=“CLI”
        NameSpace=“Cisco” />
  - <TechnologyGroup Name=“Security” Description=“All Security Related Technologies”>
    - <Technology Name=“Accounting”>
        <FunctionGroup Name=“AAA Accounting” />
    </Technology>
    - <Technology Name=“Authentication”>
        <FunctionGroup Name=“AAA Authentication” />
    </Technology>
    - <Technology Name=“Authorization”>
        <FunctionGroup Name=“AAA Authorization” />
    </Technology>
    - <Technology Name=“Security Server Protocols”>
        <FunctionGroup Name=“Kerberos” />
        <FunctionGroup Name=“Tacacs” />
        <FunctionGroup Name=“Extended Tacacs” />
        <FunctionGroup Name=“Tacacs +” />
        <FunctionGroup Name=“Radius” />
    </Technology>
    - <Technology Name=“Traffic Filtering”>
        <FunctionGroup Name=“Lock and Key” />
        <FunctionGroup Name=“TCP Intercept” />
        <FunctionGroup Name=“Context Based Access Control” />
    </Technology>
    - <Technology Name=“IP Session Filtering”>
        <FunctionGroup Name=“Reflexive Access List” />
    </Technology>
    - <Technology Name=“Intrusion Detection”>
        <FunctionGroup Name=“IP Audit” />
    </Technology>
    - <Technology Name=“Firewall Authentication”>
        <FunctionGroup Name=“Authentication Proxy” />
    </Technology>
    - <Technology Name=“Port to Application Mapping”>
        <FunctionGroup Name=“Port Map” />
    </Technology>
    - <Technology Name=“Encryption”>
        <FunctionGroup Name=“Encryption” />
        <FunctionGroup Name=“Crypto” />
        <FunctionGroup Name=“Access List Encryption” />
    </Technology>
    - <Technology Name=“IPSec”>
        <FunctionGroup Name=“IPSec” />
    </Technology>
    - <Technology Name=“Certificate Authority”>
        <FunctionGroup Name=“CA” />
    </Technology>
    - <Technology Name=“Internet Key Exchange”>
      <FunctionGroup Name=“Crypto” />
      <FunctionGroup Name=“IKE Policy” />
    </Technology>
    - <Technology Name=“Password and Privileges”>
      - <FunctionGroup Name=“Password Privileges”>
        - <CommonName Name=“username”>
          - <Management Object Name=“username”>
            - <CiscoCLIDefinition>
                <FCAPS Name=“Configuration” />
                <CliKeyword Name=“username” Required=“true” />
                <CliString Name“username” Required=“true” />
              </CiscoCLIDefinition>
          </Management Object>
        </CommonName>
        - <CommonName Name=“password”>
          - <Management Object Name=“password”>
            - </CiscoCLIDefinition>
                <FCAPS Name=“Configuration” />
                <CliKeyword Name=“password” Required=“true” />
                <CliString Name=“password” Required=“true” />
            </CiscoCLIDefinition>
          </Management Object>
        </CommonName>
        - <CommonName Name=“enable password”>
          - <Management Object Name=“enable password”>
            - <CiscoCLIDefinition>
                <FCAPS Name=“Configuration” />
                <CliKeyword Name=“enable” Required=“true” />
                <CliKeyword Name=“password” Required=“true” />
                <CliString Name=“password” Required=“true” />
              </CiscoCLIDefinition>
          </Management Object>
        </CommonName>
      </FunctionGroup>
    </Technology>
    - <Technology Name=“IP Security Options”>
      <FunctionGroup Name=“DNS” />
      <FunctionGroup Name=“IP Security” />
    </Technology>
    - <Technology Name=“Unicast Reverse Forwarding”>
      <FunctionGroup Name=“IP Verification” />
    </Technology>
    - <Technology Name=“Access Control”>
      - <FunctionGroup Name=“Access Class”>
        - <CommonName Description=“Controlls incoming and outgoing
            connections between virtual terminal line into a device) and the
            addressin an access list.” Name=“Access Class”>
          - <Management Object Name=“Access Class” AccessMethod=“CLI”
                IndexType=“Scalar”>
            - <CiscoCLIDefinition Name=“access class” Description=“To
                  restrict incomming and outgoing connections between a
                  particlar vitrual termianl line”
                  ErrorHandling=“Terminate”>
                <FCAPS Name=“Configuration” />
          <FCAPS Name=“Configuration Check” />
          <Mode Name=“Global Configuration Mode” />
          <Mode Name=“No” />
          - <CliKeyword Name=“access-class” Required=“true”>
            - <CliInteger Name=“access-list-number”
                  Required=“true”>
                <Range Min=“1” Max=“199” />
                <Range Min=“1300” Max=“2699” />
            </CliInteger>
          </CliKeyword>
          - <CliEnumeration Name=“direction” Required=“true”
                ReleaseRestriction=“11.1 - *”>
            <Enum Name=“in” />
            <Enum Name=“out” />
          </CliEnumeration>
        </CiscoCLIDefinition>
      </Management Object>
    </CommonName>
    - <CommonName Name=“Access List”>
      - <Management Object Name=“access list” IndexType=“Table”>
        - <CiscoCLIDefinition Name=“access-list”>
          - <CliKeyword Name=“access-list” Required=“true”>
            - <CliInteger Name=“access-list-number”
                Required=“true”>
              <Range Min=“100” Max=“199” />
              <Range Min=“2000” Max=“2699” />
              </CliInteger>
          </CliKeyword>
          - <CliKeyword Name=“dynamic” Required=“false”>
            <CliString Name=“dynamic-name” Required=“true”
                />
            - <CliKeyword Name=“timeout” Required=“false”>
              <CliInteger Name=“minutes” Required=“true”
                  />
            </CliKeyword>
          </CliKeyword>
          - <CliEnumeration Name=“” Required=“true”>
            <Enum Name=“deny” />
            <Enum Name=“permit” />
          </CliEnumeration>
          <CliKeyword Name=“icmp” Required=“true” />
          <CliString Name=“source” Required=“true” />
          <CliString Name=“source-wildcard” Required=“true” />
          <CliString Name=“distination” Required=“true” />
          <CliString Name=“distination-wildcard” Required=“true”
              />
          - <CliInteger Name=“icmp-type” Required=“false”>
            <Range Min=“0” Max=“255” />
            - <CliInteger Name=“icmp-code” Required=“false”>
                <Range Min=“0” Max=“255” />
            </CliInteger>
            <CliString Name=“icmp-message” Required=“false”
                />
          </CliInteger>
              - <CliKeyword Name=“precedence” Required=“false”>
                - <CliInteger Name=“precedence” Required=“true”>
                    <Range Min=“0” Max=“7” />
                </CliInteger>
              </CliKeyword>
              - <CliKeyword Name=“tos” Required=“false”>
                - <CliInteger Name=“tos” Required=“true”>
                    <Range Min=“0” Max=“15” />
                </CliInteger>
              </CliKeyword>
              - <CliEnumeration Name=“log” Required=“false”>
                <Enum Name=“log” />
                <Enum Name=“log-input” />
              </CliEnumeration>
              - <CliKeyword Name=“time-range” Required=“false”>
                <CliString Name=“time-range-name”
                  Required=“true” />
              </CliKeyword>
              - <CliEnumeration Name=“fragments” Required=“false”>
                <Enum Name=“fragments” />
              </CliEnumeration>
            </CiscoCLIDefinition>
          </Management Object>
        </CommonName>
      </FunctionGroup>
    </Technology>
  </TechnologyGroup>
</TechnologyOSIM
```

Other embodiments are also within the scope of the following claims.

1. A method executing network management software for managing devices on a network, the method comprises:
mapping high level abstract objects to specific to specific vendor, model, firmware, release, or configuration-specific objects to provision and manage the network.

2. The method of claim 1, wherein objects are Management Objects that are independently defined from a method of access protocol used to convey the objects to the managed devices.

3. The method of claim 2, wherein the access protocol used to convey the Management Objects associates classes to each management object that includes details including device protocol, object interactions and security parameters associated with the management objects

4. The method of claim 1, wherein objects are Management Objects that represent multiple distinct name spaces.

5. The method of claim 4, further comprising:
producing high level abstractions from the management objects.

6. The method of claim 4, further comprising: grouping related objects according to objects required to monition a function configured on a monitored device.

7. The method of claim 1 wherein the network includes software and further comprising:
integrating a new device to be incorporated into the network without modification of the software by adding a new object.

8. The method of claim 7, wherein integrating comprises adding new objects, wherein a relationship of the new object to other objects is provided by assigning metadata to the other objects and associating the metadata in a new instance of the new object with a generic form found in a Common Name class to allow managing of multi-vendor, multi-technology networks.

9. A method of managing a network, comprising:
determining a relationship between fault information, accounting, performance or security information to configuration data; and
tagging objects in the network with data that identifies the type of management function the objects perform.

10. The method of claim 9 wherein each management object carries an attribute of the types of management data including fault, configuration, verification of configuration, accounting, performance or security that the management object supports.

11. The method of claim 10 wherein the attribute is metadata and is used to determine performance of monitoring service level agreement verification.

12. The method of claim 10 wherein tagging enables identification of objects used to verify correct configuration and to verify performance levels or usage based on a specific configuration.

13. A method of managing a network, the method comprises:
mapping high-level business requirements and service level objectives to low-level commands and management objects that show the status of network devices by integration from the low-level objects understood by network devices with the high-level business concepts understood at the business level of the organization into a single environment.

14. A method of managing a network, comprising:
integrating of analysis at all levels of the hierarchy by providing mini-analytic modules associated with every object in the system involved in delivering a specific service.

15. The method of claim 14 wherein integrating includes effective, accurate and timely fault reporting while reducing an overall load to the network.

16. An apparatus for rating an item, comprising:
a memory that stores executable instructions; and
a processor that executes the instructions to:
map high level abstract objects to specific to specific vendor, model, firmware, release, or configuration-specific objects to provision and manage the network.

17. An article comprising a machine-readable medium that stores executable instructions for rating an item, the instructions causing a machine to:
map high level abstract objects to specific to specific vendor, model, firmware, release, or configuration-specific objects to provision and manage the network.
